(19) United States
(12) Patent Application Publication
(10) Pub. No.: US 2024/0195690 A1
(43) Pub. Date: Jun. 13, 2024

(54) MANAGING INTERNAL CONFIGURATION OF A COMMUNICATION NODE

(71) Applicant: Telefonaktiebolaget LM Ericsson (publ), Stockholm (SE)

(72) Inventors: Ajay KATTEPUR, Bangalore (IN); Swarup Kumar MOHALIK, Bangalore (IN); Sushanth S DAVID, Frisco, TX (US)

(21) Appl. No.: 18/287,772

(22) PCT Filed: Apr. 23, 2021
(86) PCT No.: PCT/EP2021/060683

§ 371 Date: Oct. 20, 2023

(51) Int. Cl. H04L 41/0823; H04L 41/0894; H04L 41/142; H04L 41/16; H04L 43/08

(52) U.S. Cl. CPC H04L 41/0823; H04L 41/0894; H04L 41/142; H04L 41/16; H04L 43/08

(57) ABSTRACT

A computer implemented method is disclosed for generating a policy for managing a configuration of internal components of a communication network node. The method includes obtaining performance data and generating a model of the communication network node The method further includes using the model to generate a first data set; and extracting, from the first data set: a set of conditional probabilities of operational state transition for the communication network node; and a set of conditional probabilities of changes in observed measure of performance for the communication network node. The method further comprises includes combining the extracted sets of conditional probabilities with a reward function to form a configuration model and generating a solution to the configuration model including a policy that is operable to propose a change in configuration of an internal component of the communication network node based on an observed measure of performance of the communication network node.

### TECHNICAL FIELD

The present disclosure relates to methods for generating and using a policy for managing internal configuration of a communication network node. The present disclosure also relates to a training node, a management node and to a computer program.

### BACKGROUND

5G telecommunication systems are inherently complex, and while they have the potential to greatly improve connectivity of many different systems and devices, their complexity can result in inefficient use of scarce network resources. For example, in order to provide highly specialized service characteristics required by a user, the differentiation in services that 5G offers is not limited to bundles at product level, but is deployed deep in the network level. This results in fragmentation of resource pools, which can potentially result in inefficiency. Guaranteed Quality of Service (QOS) controls are achievable, but only if network resources can be made available dynamically and on demand. A solution which provisions for maximum expected demand for a particular day would not only result in wasted resources, as the maximum demand would likely not be met, but would also result in lost opportunity to direct resources to a different need. Dynamic management of resources in a network is consequently an ongoing challenge for 5G systems.

Edge and aggregation routers are a key component in managing QoS in 5G telecommunication systems, performing congestion control and routing transport layer traffic efficiently. Router models such as Ericsson 6000 series and Juniper M-series provide high capacity 10 Gigabit to 100 Gigabit Ethernet port interfaces that can provide the QoS support for 5G enabled networks.

Techniques such as Reinforcement Learning (RL) have been exploited in routing traffic over networks. Research in this area includes “Packet Routing in Dynamically Changing Networks: A Reinforcement Learning Approach” by J. Boyan and M. Littman, Advances in Neural Information Processing Systems, vol. 6 (1994), and “A Deep Reinforcement Learning Perspective on Internet Congestion Control” by N. Jay et al, Proceedings of the 36th International Conference on Machine Learning, PMLR 97:3050-3059, 2019, both of which disclose automated traffic routing methods for effective congestion control.

### SUMMARY

While the above discussed research seeks to improve congestion control and routing efficiency, at a network or sub-net level, in order to provide the stringent QoS support guaranteed by 5G network slicing, queue management and port configurations at edge and aggregation routers should be resilient to changes in traffic patterns. Router configuration and queue management is currently a human expert driven process, with multiple configuration commands provided for each QoS flow. Such a technique is neither a scalable nor an optimal approach to controlling router configurations in 5G networks. Expert driven techniques can result in hardcoded rules that are not scalable, and well as policies that may be infeasible or sub-optimal for a particular set of network conditions. Additionally, new problems which have not previously been seen cannot be easily diagnosed or addressed. Automated and dynamic management of the internal configurations of routers and other networking components consequently has the potential to provide significant advantages for 5G and other telecommunications systems.

It is an aim of the present disclosure to provide methods, a training node, a management node, and a computer readable medium which at least partially address one or more of the challenges discussed above. It is a further aim of the present disclosure to provide methods, a training node, a management node, and a computer readable medium which facilitate dynamic management of the internal configurations of networking components, so as to provide improved support for QoS in 5G and other networks.

According to a first aspect of the present disclosure, there is provided a computer implemented method for generating a policy for managing a configuration of internal components of a communication network node, wherein the communication network node is operable to process an input data flow. The method comprises obtaining performance data for the communication network node during a period of operation, and generating a model of the communication network node using the obtained performance data. The model represents an operational state of the communication network node for a given input data flow, wherein the operational state of the communication network node comprises a combined state formed from operational states of internal components of the communication network node. The method further comprises using the model of the communication network node to generate a first data set. The first data set comprises, for a given input data flow to the communication network node, and for given configurations of internal components of the communication network node: a representation of the operational state of the communication network node, and an observed measure of performance of the communication network node. The method also comprises extracting, from the first data set, a set of conditional probabilities of operational state transition for the communication network node, and a set of conditional probabilities of changes in observed measure of performance for the communication network node. The method further comprises combining the extracted sets of conditional probabilities with a reward function for the communication network node performance to form a configuration model for the communication network node, and generating a solution to the configuration model. The solution comprises a policy that is operable to propose a change in configuration of an internal component of the communication network node based on an observed measure of performance of the communication network node.

According to a second aspect of the present disclosure, there is provided a computer implemented method for using a policy to manage a configuration of internal components of a communication network node, wherein the communication network node is operable to process an input data flow. The method, performed by a management node, comprises obtaining the policy from a training node, wherein the policy is operable to propose a change in configuration of an internal component of the communication network node based on an observed measure of performance of the communication network node, and has been generated using a method according to the first aspect of the present disclosure. The method further comprises receiving an observed measure of performance of the communication network node, and using the policy to propose, based on the received observed measure of performance, a change in configuration of an internal component of the communication network node. The method also comprises causing the proposed change in configuration to be executed on the internal component of the communication network node, and receiving an updated observed measure of performance of the communication network node following execution of the change in configuration.

According to a third aspect of the present disclosure there is provided a training node for generating a policy for managing a configuration of internal components of a communication network node, wherein the communication network node is operable to process an input data flow. The training node comprises processing circuitry configured to cause the training node to obtain performance data for the communication network node during a period of operation, and generate a model of the communication network node using the obtained performance data. The model represents an operational state of the communication network node for a given input data flow, the operational state of the communication network node comprising a combined state formed from operational states of internal components of the communication network node. The processing circuitry is further configured to cause the training node to use the model of the communication network node to generate a first data set comprising, for a given input data flow to the communication network node, and for given configurations of internal components of the communication network node, a representation of the operational state of the communication network node, and an observed measure of performance of the communication network node. The processing circuitry is further configured to cause the training node to extract, from the first data set, a set of conditional probabilities of operational state transition for the communication network node, and a set of conditional probabilities of changes in observed measure of performance for the communication network node, and to combine the extracted sets of conditional probabilities with a reward function for the communication network node performance to form a configuration model for the communication network node. The processing circuitry is further configured to cause the training node to generate a solution to the configuration model, the solution comprising a policy that is operable to propose a change in configuration of an internal component of the communication network node based on an observed measure of performance of the communication network node.

According to a fourth aspect of the present disclosure, there is provided a management node for using a policy to manage a configuration of internal components of a communication network node, wherein the communication network node is operable to process an input data flow. The management node comprises processing circuitry configured to cause the management node to obtain the policy from a training node, wherein the policy is operable to propose a change in configuration of an internal component of the communication network node based on an observed measure of performance of the communication network node, and has been generated by a training node according to the third aspect of the present disclosure. The processing circuitry is further configured to cause the management node to receive an observed measure of performance of the communication network node, and to use the policy to propose, based on the received observed measure of performance, a change in configuration of an internal component of the communication network node. The processing circuitry is further configured to cause the management node to cause the proposed change in configuration to be executed on the internal component of the communication network node, and to receive an updated observed measure of performance of the communication network node following execution of the change in configuration.

### BRIEF DESCRIPTION OF THE DRAWINGS

For a better understanding of the present disclosure, and to show more clearly how it may be carried into effect, reference will now be made, by way of example, to the following drawings in which:

FIG. 1 is a flow chart illustrating process steps in a computer implemented method for generating a policy for managing configuration of internal components of a communication network node;

FIGS. 2a-e show a flow chart illustrating process steps in another example of a computer implemented method for generating a policy for managing configuration of internal components of a communication network node;

FIG. 3 is a flow chart illustrating process steps in a computer implemented method for using a policy to manage a configuration of internal components of a communication network node;

FIGS. 4a-b show a flow chart illustrating process steps in another computer implemented method for using a policy to manage a configuration of internal components of a communication network node;

FIG. 5 is a block diagram illustrating functional modules in a training node;

FIG. 6 is a block diagram illustrating functional modules in a management node;

FIG. 7 is a schematic example of the operation of a partially observable Markov Decision making process (POMDP) model;

FIG. 8 is an example of a network architecture;

FIG. 9 is a signalling diagram illustrating an example of a message flow;

FIG. 10 is an example of a router;

FIG. 11 is example of a priority weighted fair queuing (PWFQ) policy;

FIG. 12 is an example of an algorithm;

FIG. 13 is an example profile of dropping packets;

FIG. 14 is an example of a scenario illustrating a misconfigured router port;

FIG. 15 is an example of network traffic;

FIG. 16 is an example of a port configuration for a router;

FIGS. 17a-c are examples of traffic across queues of a router;

FIG. 18 is an example of a router simulation;

FIG. 19 is an example of threshold for marking queue utilization;

FIG. 20 is another example of an algorithm;

FIG. 21 is an example of performance parameters of ingress queues of a router;

FIG. 22 is an example of changes in performance parameters of ingress queues of a router;

FIG. 23 is an example of rewards generated by a reward function;

FIG. 24 is an example of a policy graph;

FIG. 25 is an example graph showing queue utilization changes with configuration changes;

FIG. 26 is an example of performance parameters of egress queues of a router;

FIG. 27 is an example of changes in performance parameters of egress queues of a router;

FIG. 28 is another example of a policy graph;

FIGS. 29a and 29b are further example graphs showing queue utilization changes with configuration changes;

FIG. 30 is another example of network traffic patterns;

FIG. 31 is another example graph showing queue utilization changes with configuration changes.

### DETAILED DESCRIPTION

As discussed above, there is currently a lack of automated methods for managing network underlay component configurations, such as router ports, which methods take into account dynamic system and environment changes. Such methods would imply specific understanding of internal queueing mechanisms, as well as effective management of actions and viable configuration changes, all of which are all unobservable within routers once operational and deployed in a network. Examples of the present disclosure propose methods for generating and using a policy for managing configuration of internal components of a communication network node. The communication network node may be a networking device, such as a router or switch, and the internal components of the communication network node may for example include at least one port queue of the networking device. In the present disclosure, an example networking device in the form of a router is discussed in detail, but it will be appreciated that the discussion is equally applicable to other example networking devices including switches. References to a router should consequently be understood as references to an illustrative example of a networking device.

Example methods discussed herein use a reinforcement learning (RL) approach to derive an optimal management policy incorporating changes in traffic patterns, congestion, queue length, packet drops etc. Example methods firstly involve generating a detailed queueing model for the communication network node whose internal configuration is to be managed, modelling traffic patterns, congestion, queue length and packet drops etc. The queueing network model is then transformed into a probabilistic model, such as a Partially Observable Markov Decision Process (POMDP) model, which is able to capture uncertainties in observable communication network node performance metrics, such as throughput. Such metrics are examples of ‘observations’, which may be gathered according to examples of the method disclosed herein. The probabilistic model is also able to account for uncertainties in the underlying operational state of the communication network node, such as a utilization of a queue in a router. The probabilistic model includes sets of conditional probabilities associated with operational state of the communication network node, and with observation transitions of the communication network node conditional upon actions that may affect the operational state or observations of the communication network node. For example, the conditional probabilities may express a likelihood that a particular action will result in a particular change in operational state and/or observation. The probabilistic model is then used in a model-based reinforcement learning process to develop a policy for managing a configuration of internal components of a communication network node. For example, if the communication network node comprises a router, the policy may propose, in response to observable changes in traffic flow, configuration changes in queue priorities, virtual interfaces, queuing models, traffic shaping and QoS requirements etc. The policy is then applied to a communication network node to adjust the configuration of internal components of the communication network node in a network environment. The policy may be tuned during online operation in response to observed output metrics following actions taken by the policy.

The policy developed according to example of the present disclosure thus provides management that enables dynamically changing the configuration of internal commination network node components in response to particular network requirements. The probabilistic model used to generate the policy can be used to generate a belief as to the operational state of the internal components of a communication network node, such as the queue state of a router, which state is not observable once the router is deployed. Based on the observations from the router, such as throughput, packet drop rate etc., and the mapping provided by the policy to a belief about the states of the internal router components, the policy can propose actions in the form of internal configuration changes that are expected to improve the observable performance of the router, and so support connectivity speed and QoS requirements for 5G and other telecommunications systems.

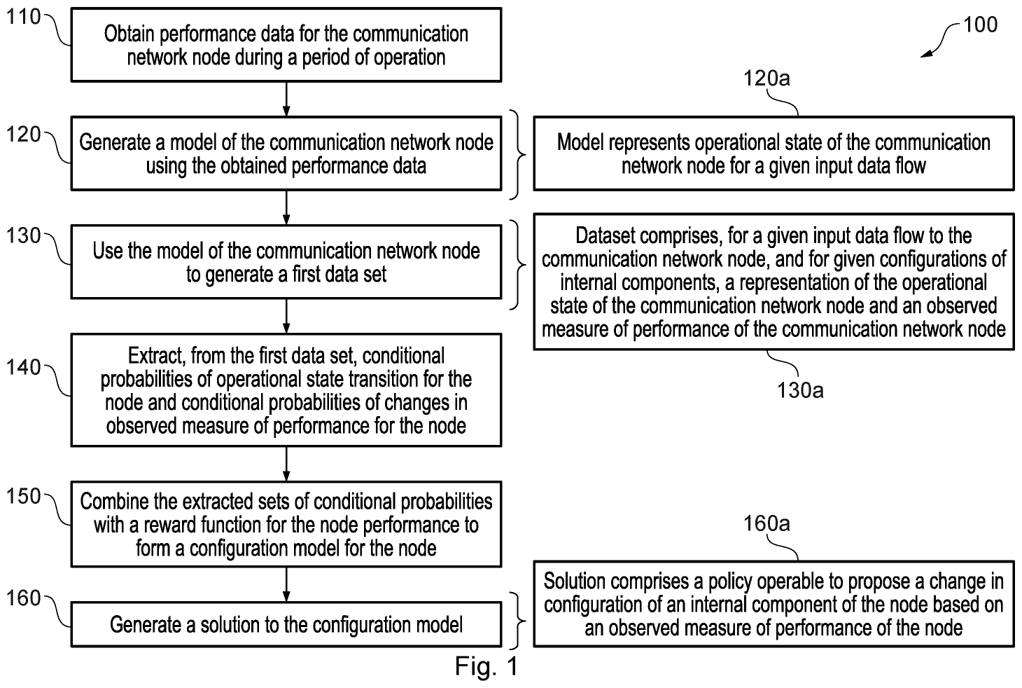

FIG. 1 is a flow chart illustrating process steps in a computer implemented method 100 for generating a policy for managing configuration of internal components of a communication network node, such as a router. The method 100 is performed by a training node, which may comprise a physical or virtual node, and may be implemented in a computing device or server apparatus and/or in a virtualized environment, for example in a cloud, edge cloud or fog deployment. The training node may for example be implemented in a core network of the communication network. The training node may encompass multiple logical entities, as discussed in greater detail below, and may for example comprise a Virtualised Network Function (VNF).

Referring to FIG. 1, the method comprises, in a first step 110, obtaining performance data for the communication network node during a period of operation. The performance data may for example comprise traffic flows at the ingress or egress queue ports of a router. The method further comprises, in step 120, generating a model of the communication network node using the obtained performance data. As illustrated in step 120a, the model represents an operational state of the communication network node for a given input data flow. The operational state of the communication network node comprises a combined state formed from operational states of internal components of the communication network node. In some examples, the model may be operable to represent the ingress and/or egress queues within a router for a given input data flow to the router. For example, the model may be operable to represent various configuration options for different traffic flows into the router, and represent observable performance parameters, such as key performance indicator (KPI) outputs, including packet drop rates, latency, throughput etc.

Referring again to FIG. 1, the method further comprises, in step 130, using the model of the communication network node to generate a first data set. As illustrated at 130a, the data set comprises, for a given input data flow to the communication network node, and for given configurations of internal components of the communication network node, a representation of the operational state of the communication network node, and an observed measure of performance of the communication network node. In some examples, a range of configurations of internal components of the communication network node may be input to the model, together with a range of input traffic flows, with the model outputting corresponding representations of the operational state of the communication network node, and observable performance measures. In this manner, the dataset generated using the model may provide a representation of the how the operational state of the node, and observable metrics of node performance (e.g. latency, packet drop rate etc.) may vary with input traffic flow under different configurations of internal components of the node.

Referring still to FIG. 1, the method further comprises, in step 140, extracting, from the first data set, a set of conditional probabilities of operational state transition for the communication network node, and a set of conditional probabilities of changes in observed measure of performance for the communication network node. The transition probabilities may represent a likelihood that a specific change to an internal component of the communication node, which may be termed an ‘action’ will result in a specific change to the operational state of internal components of the node, and a specific change to observed measures of performance of the node. In the example of a communication network node comprising a router, the operational state of an internal component of the router may comprise a utilization state of one of the router queues. A transition probability may thus provide a probability that a utilization state of a queue has transitioned from one value to another value based on an applied action.

The method further comprises, in step 150, combining the extracted sets of conditional probabilities with a reward function for the communication network node performance to form a configuration model for the communication network node. The method further comprises in step 160, generating a solution to the configuration model. As illustrated at 160a, the solution comprises a policy that is operable to propose a change in configuration of an internal component of the communication network node based on an observed measure of performance of the communication network node.

The method 100 thus results in a policy that can manage, in an online manner, the configuration of internal components of a node whose operational state cannot be directly observed: the policy maps from a global observation of the node to internal component configuration changes, having been training using data generated from the initial node model. In this manner, improved node performance can be achieved through optimal internal configuration on the fly.

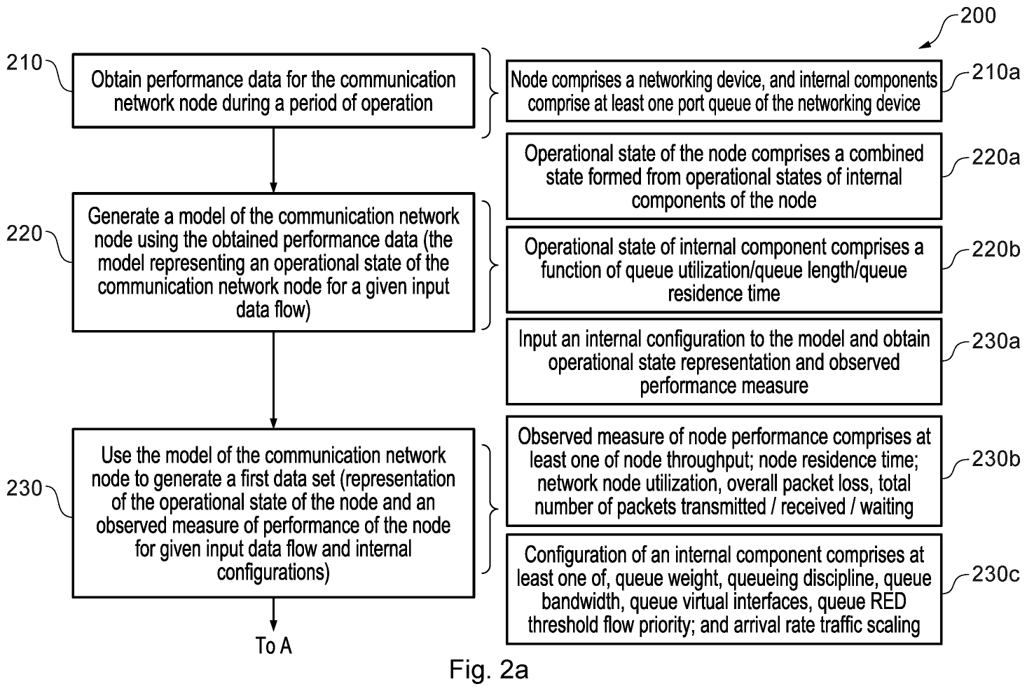

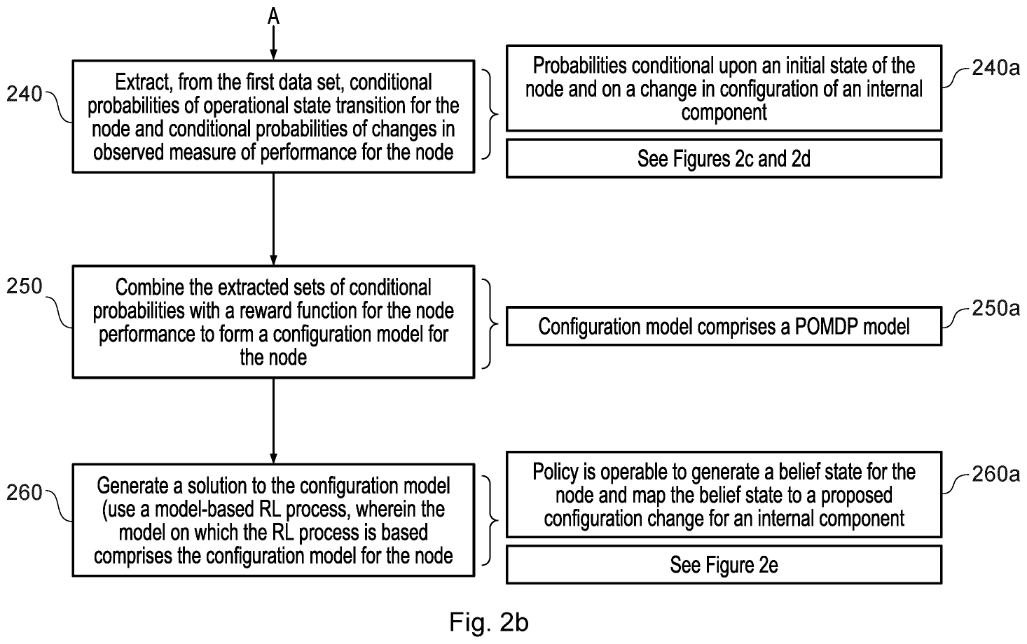

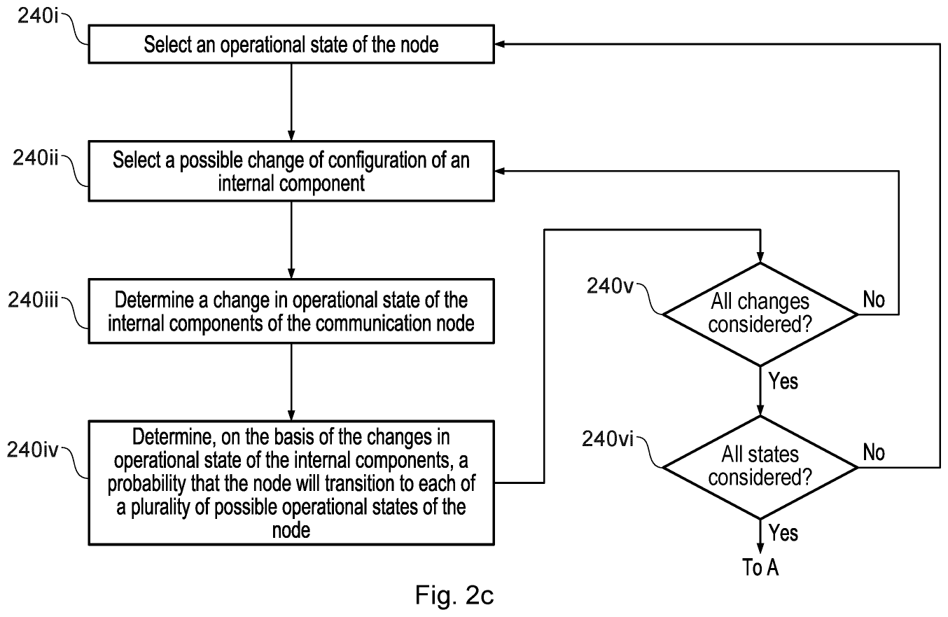

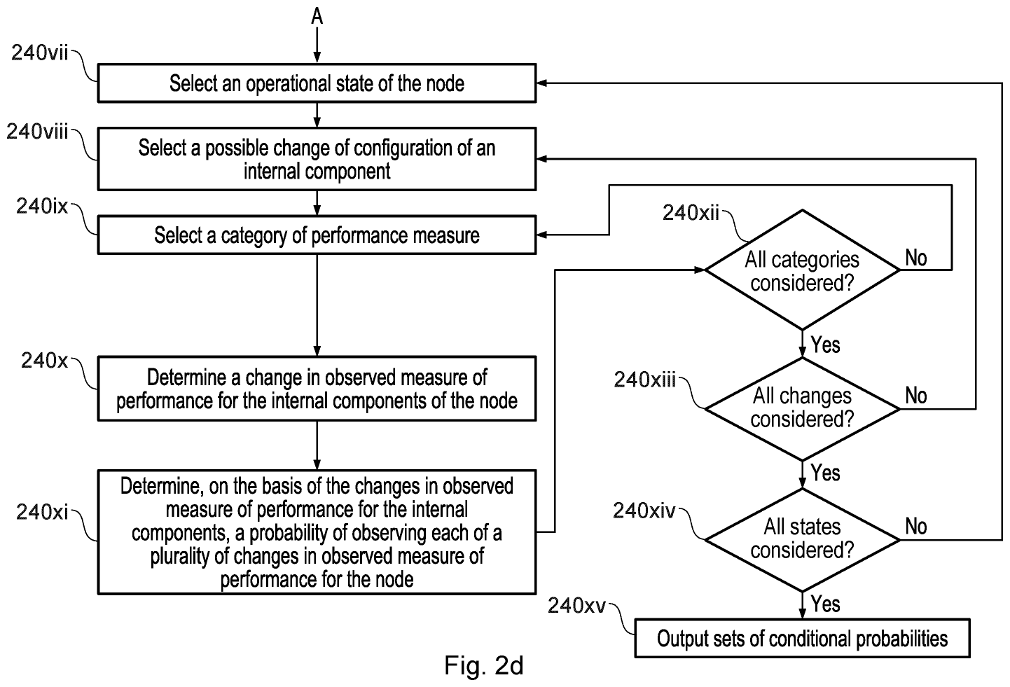

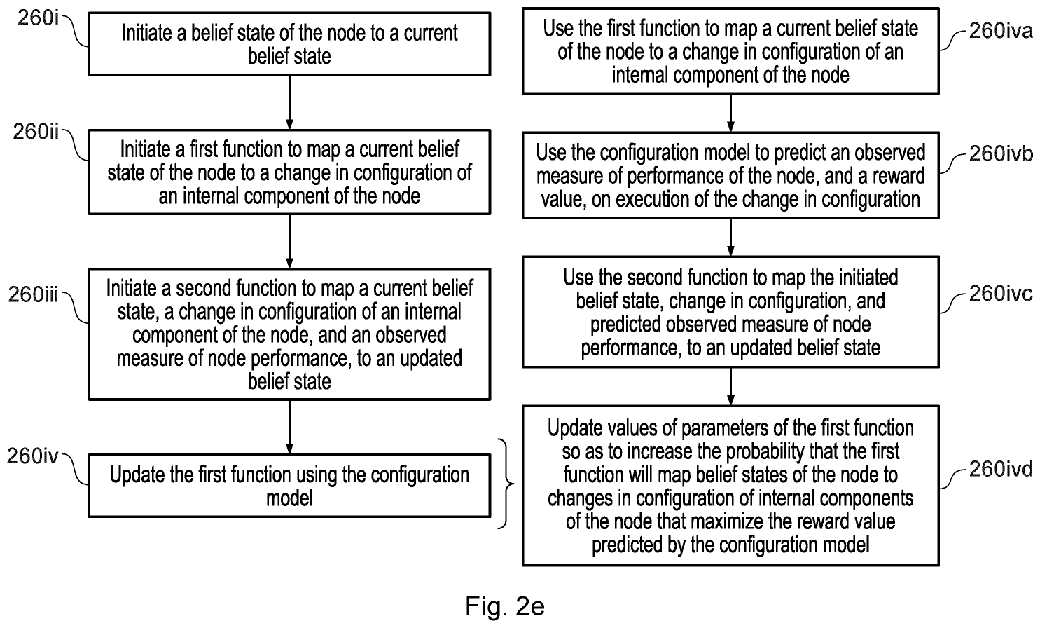

FIGS. 2a-e show a flow chart illustrating process steps in another example of a computer implemented method for generating a policy for managing a configuration of internal components of a communication network node. As for the method 100 above, the method 200 is performed by a training node, which may comprise a physical or virtual node, and may be implemented in a computing device or server apparatus and/or in a virtualized environment, for example in a cloud, edge cloud or fog deployment. The method 200 provides one example of how the steps of the method 100 may be implemented and supplemented to achieve the above discussed and additional functionality.

Referring to FIG. 2a, the method 200 comprises, in a first step 210, obtaining performance data for the communication network node during a period of operation. As illustrated in step 210a, the communication network node may comprise a networking device, and the internal components of the communication network node may comprise at least one port queue of the networking device, which may be an ingress or an egress port queue. In some examples, the networking device may comprise a router or switch having one or more queues for directing the flow of data packets. In such examples, the performance data may comprise data traffic flows into the device and corresponding performance measures for the device.

In step 220, the method further comprises generating a model of the communication network node using the obtained performance data, the model representing an operational state of the communication network node for a given input data flow. As illustrated at 220a, the operational state of the communication network node may comprise a combined state formed from operational states of internal components of the communication network node. As illustrated in step 220b, in the example of a node comprising a networking device, the operational state of an internal component of the device may comprise a function of at least one of: queue utilization; queue length; queue residence time of a port queue of the networking device.

Referring again to FIG. 2a, in step 230, the method further comprises using the model of the communication network node to generate a first data set comprising, for a given input data flow to the communication network node, and for given configurations of internal components of the communication network node, a representation of the operational state of the communication network node, and an observed measure of performance of the communication network node. As illustrated at 230a, using the model of the communication network node to generate the first data set may comprise, inputting to the model a configuration of internal components of the communication network node and obtaining model outputs comprising a representation of the operational state of the communication network node and an observed measure of performance of the communication network node. As discussed above, the operational state of the communication network node comprises a combined state formed from operational states of internal components of the communication network node, and the representation thus indicates the operational states of individual internal components of the node. For example, the representation of the operational state of the node may indicate queue states for individual router queues. The queue states may be based on queue utilization, queue length, etc., and the first data set associates a given input configuration of the internal components (queue weight; queueing discipline; queue bandwidth etc.) and input data flow to the node, with corresponding observable measures of performance of the node (throughput, latency, etc.) and individual queue states.

Using the model to generate the first data set may further comprise changing a configuration of an internal component of the communication network node, and obtaining model outputs comprising an updated representation of the operational state of the communication network node and an updated observed measure of performance of the communication network node. Thus, in some examples, the configuration of the internal components of a network node, such as a router, may be repeatedly changed to explore performance measures and internal component states for a range of different configuration options for the internal components of the node, and for a range of different input traffic flows. Updated representations of the operational state, for example queue utilization, and updated observed measures of performance, for example throughput, may thus be obtained in response to the different internal component configurations and different input traffic flows. The first data set assembled in this manner can be used to generate a probabilistic model of how node state and performance may evolve with changing internal configuration and network conditions in later method steps. In some examples, the nature of the changes in configuration that are input to the model may be driven by a reward structure that seeks to optimize some network or component level criterion. This may include for example a fair queue utilization criterion, strict adherence to assigned priorities, or some other criterion on which a reward structure may be based.

It will be appreciated that the steps of inputting internal component configuration to the model, observing model outputs, changing the internal configuration and obtaining updated outputs may be repeated for a range of different configuration options for the internal components of the node, and for a range of different input traffic flows, in order to build a relatively complete picture of the response of the node and its internal components to different internal configuration and traffic flows, as predicted by the model. As the operational state of the node is formed from the operational states of the internal components, the output of the model by definition includes the operational states of the internal components. As discussed above, this modelling of the operational states of the internal components (e.g. change in queue utilization, length, residence time, etc. which can be mapped to queue state), that enables generation of a probabilistic model of node behaviour in later method steps, and consequently the training of a policy that will manage configuration of internal components based on global observed performance measures for the node.

Referring still to FIG. 2a, and as illustrated at 230b, the observed measure of communication network node performance may comprise at least one of communication network node throughput, communication network node residence time, network node utilization, overall packet loss, total number of packets transmitted, total number of packets received, and/or total number of packets waiting to be transmitted or received. As illustrated at 230c, a configuration of an internal component of the communication network node may comprise at least one of queue weight, queueing discipline, queue bandwidth, queue virtual interfaces, queue Random Early Drop (RED) threshold, flow priority, and/or arrival rate traffic scaling.

Referring now to FIG. 2b, method 200 further comprises in step 240, extracting, from the first data set, a set of conditional probabilities of operational state transition for the communication network node and a set of conditional probabilities of changes in observed measure of performance for the communication network node. As illustrated at 240a, the conditional probabilities of operational state transition for the communication network node, and the conditional probabilities of changes in observed measure of performance for the communication network node, may be conditional upon an initial state of the communication network node and on a change in configuration of an internal component.

As will be discussed in more detail with reference to FIGS. 2c and 2d, a set of conditional probabilities are thus extracted for particular transitions of the operational state of the communication network node, and changes to the observed measure of performance for the communication network node, in response to a change in configuration of an internal component applied when the communication network node is in an initial operational state (the node operational state being formed from the operational states of its internal components). For example, an initial state of the node may include a queue utilization state of one of its queues that is yellow, a queue utilization value of 30% having been mapped to a queue state for the queue of green. An observed measure of performance for the node in its initial state may be a throughput of 320 Mbps. An increase in queue utilization of 20% would cause the queue state to transition to yellow. A conditional probability for an operational state transition in which the particular queue state transitions from green to yellow may be extracted by determining the probability that the queue utilization value of the particular queue will increase by 20%, as a consequence of a specific internal configuration change, for example increasing the weight of a queue of a router. In a similar manner, a conditional probability that the throughput of the node will increase to 400 Mbps as a consequence of the same change to the configuration of an internal component, such as increasing the weight of a queue of a router, can be extracted. Such conditional probabilities may be generated in an exhaustive manner, until conditional probabilities for all possible state transitions and changes in observed performance measures of performance of the node have been extracted for all possible configuration changes from a given initial state. As will be described in more detail below, the set of conditional probabilities can then be combined with a reward function to generate a policy for managing configuration of internal components of a communication network node.

FIGS. 2c and 2d illustrate in greater detail steps that may be carried out in order to extract the conditional probabilities at step 240. FIGS. 2c and 2d thus represent one example of how a training node performing the method 200 may implement step 240. FIG. 2c illustrates extraction of conditional probabilities of operational state change, and FIG. 2d illustrates extraction of conditional probabilities of change sin observed measure of node performance.

Referring to FIG. 2c, extracting the set of conditional probabilities may comprise, in a first step 240i the training node selecting an operational state of the communication network node, and in step 240ii, selecting a possible change of configuration of an internal component. The selected operational state may represents an initial operational state of the node, and it will be appreciated that not all configuration changes will be possible in all states, for example if an initial state of the communication network node involves a minimum priority level being associated to a particular queue, reducing the priority of that queue is not a possible action for that state. In step 240ii, the training node determines, from the first data set, a change in operational state of the internal components of the communication network node that would result from the selected action, and, in step 240iv, determines, on the basis of the changes in operational state of the internal components, a probability that the communication network node will transition to each of a plurality of possible operational states of the communication network node.

It will be appreciated that, as discussed above, the representation of an operational state of the communication network node that is included in the first data set may comprise utilization data (or queue length or residency time data) for individual queues, which data can be mapped to the individual queue states which form the combined state of the node. For example, specific utilization, length, or residency time values may be mapped to high, medium, and low, or red, yellow, and green queue states. Determining a change in operational state of an individual queue may therefore comprise obtaining from the first data set the change in utilization (or length or residency time) of the queue, and mapping that change in utilization (or length or residency time) to an operational queue state, for example using threshold values for the different states.

Referring still to FIG. 2c, the training node checks, in step 240v, whether conditional probabilities of operational state transitions have been determined for all changes of configuration of the internal components that are possible in the currently selected initial operational state. If no at step 240v, the training node returns to step 240ii, and selects a next possible configuration change for the currently selected operational state, before proceeding again with steps 240iii and 240iv. If yes at step 240v, the training node checks, in step 240vi, whether all operational states of the communication network node have been considered. If no at step 240vi, the training node returns to step 240i, and selects a different operational state as the initial state, before proceeding again with steps 240ii to 240v. If yes at step 240vi, the method proceeds to step 240vii.

Referring now to FIG. 2d, in step 240vii, the training node selects an operational state of the node, and in step 240ii, selects a possible change of configuration of an internal component of the node. Such selections may thus be made in a similar manner to steps 240i and 240ii, discussed above. The training node then in step 240ix, selects a category of performance measure. In some examples a category of performance measure may comprise a least one of: communication network node throughput; communication network node residence time; network node utilization, overall packet loss, total number of packets transmitted; total number of packets received; and total number of packets waiting to be transmitted or received etc.

Referring again to FIG. 2d, in step 240x, the training node determines from the first data set a change in observed measure of performance for the internal components of the communication network node as a consequence of the selected configuration change, and, in step 240xi determines, on the basis of the changes in observed measure of performance for the internal components, a probability of observing each of a plurality of changes in observed measure of performance for the communication network node. For example, the observed measure of performance may comprise communication network node throughput and the change to the internal configuration of the node may be an increase to a queue weight. Probabilities may thus be determined for the increase to the queue weight to cause the communication network node throughput to increase or decrease. In some examples, probabilities may be determined for the increase in the queue weight to result in the communication network node throughput increasing or decreasing by a particular value, for example 10% or +/−50 Mbps.

Referring again to FIG. 2d, in step 240xii, the training node assesses whether all categories of observed measures of performance for the communication network node have been considered. If not, the training node returns to step 240vii, in which a different category is selected for the conditional probability determination in steps 240x and 240xi. If yes, the training node proceeds to step 240xiii, and checks whether conditional probabilities of changes in the observed performance measure have been determined for all possible changes of configuration of internal components in the currently selected state. If not, the training node returns to step 240vii, in which a different change in configuration is selected. If yes, the training node, in step 240xvi, checks whether all operational states of the communication network node have been considered. If not, the training node returns to step 240vii, in which a different operational state is selected as the initial state and the conditional probabilities for a change in an observed performance measure based on this operational state in response to all possible internal component configuration changes are determined. If yes, the training node proceeds to step 240xv, which comprises outputting the sets of conditional probabilities.

It will be appreciated that the observed measure of performance for internal components of the communication network node may be the same as the observed measure of performance for the communication network node as a whole (i.e. throughput etc. at a queue level and at a router level). As illustrated in FIG. 2d, conditional probabilities may be extracted for a plurality of different types of observation (throughput, residence time, etc.).

Referring again to FIG. 2b, the method further comprises, in step 250, combining the extracted sets of conditional probabilities with a reward function for the communication network node performance to form a configuration model for the communication network node. As illustrated in step 250a, the configuration model for the communication network node may comprise a Partially Observable Markov Decision Process (POMDP) model. However, in other examples, an alternative configuration model may be used such as a learning automaton model.

In some examples, a POMDP model may allow for optimal decision making in environments which are only partially observable to a training agent, which may be implemented as a training node, as in the present disclosure. In general the partial observability of an environment stems from two sources: (i) multiple states which give the same sensor reading, in case the agent can only sense a limited part of the environment, and (ii) noisy sensor readings, meaning that observations on the same state can result in different sensor readings. In examples of the present disclosure, a POMDP model may be used to model a communication network node, such as a router, in which the operational state of individual internal components of the router (such as a specific queue), is not directly observable once the router is deployed in a network.

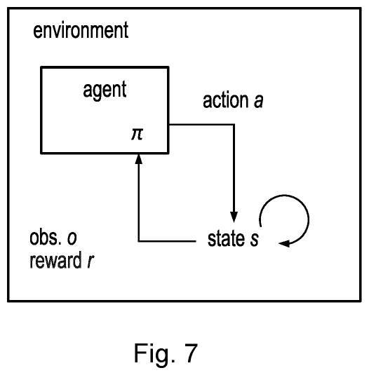

FIG. 7 illustrates the principle operation of a POMDP model, in which an agent applies an action a to an environment in a state s, observes observations o and may receive rewards r based on the observations. By interacting with the environment and receiving observations and/or rewards, the agent may update its belief in the true state of the environment by updating a representation it has of the environment state, which may be expressed as a probability distribution. This belief is updated in response to the observations and rewards that occur following execution of certain actions. In some examples, the POMDP model may thus carry out information gathering actions that are taken with the primary of objective to improve the agent's belief of the current state, thereby allowing agent to make better decisions in the future.

According to examples of the present disclosure, combining a configuration model, such as a POMDP model, for a communication network node with a reward function in a Reinforcement Learning (RL) process may thus enable a training agent to assess how certain actions affect the state of a communication network node, in order to generate a policy for managing a configuration of internal components of the communication network node. The policy is operable to map observations of communication network node performance to a belief in the current operational state of the node, comprising the operational state of its internal and unobservable components, and to map this belief to an appropriate configuration action for one or more of the internal components with the aim of maximising future reward. Reward may be defined as a function of observable communication network node performance parameters, with the particular function being set by a network operator in accordance with operator priorities.

Referring again to FIG. 2b, the method further comprises in step 260, generating a solution to the configuration model that comprises a policy that is operable to propose a change in configuration of an internal component of the communication network node based on an observed measure of performance of the communication network node using a Machine Learning (ML) process. As illustrated in FIG. 2b, the ML process comprises a model-based Reinforcement Learning (RL) process, wherein the model on which the RL process is based comprises the configuration model for the communication network node. As illustrated in step 260a, the policy is operable to generate a belief state for the communication network node and map the belief state of the communication network node to a proposed configuration change for an internal component of the communication network node. The belief state may thus comprise a belief of the operational state of the communication network node and based on this belief the policy may be able to propose a change to a configuration of an internal component of the communication network node in response to changes in the network.

FIG. 2e illustrates in greater detail steps that may be carried out in order to generate the solution at step 260. FIG. 2e thus represents one example of how a training node performing the method 200 may implement step 260.

Referring to FIG. 2e generating a solution to the configuration model that comprises a policy may comprise, in step 260i, initiating a belief state of the communication network node to a current belief state. Generating a solution may further comprise, in step 260ii, initiating a first function to map a current belief state of the communication network node to a change in configuration of an internal component of the communication network node, for example with the aim of maximising future reward, based on the conditional probabilities extracted in previous method steps. Generating a solution may further comprise, in step 260iii, initiating a second function to map a current belief state, a change in configuration of an internal component of the communication network node, and an observed measure of communication network node performance, to an updated belief state. The second function may thus generate an updated belief state based on the current belief state, a change in configuration of an internal component of the node, and an observed measure of node performance that may have resulted from the change in configuration of an internal component of the node. Generating a solution may further comprise in step 260iv updating the first function using the configuration model.

Referring still to FIG. 2e, updating the first function using the configuration model may comprise, in step, 260iva, using the first function to map a current belief state of the communication network node to a change in configuration of an internal component of the communication network node. Updating then comprises, in step 260ivb, using the configuration model to predict an observed measure of performance of the communication network node, and a reward value, on execution of the change in configuration. In step 260ivc, updating may comprise using the second function to map the initiated belief state, change in configuration, and predicted observed measure of communication network node performance, to an updated belief state. Finally, updating may comprise, in step 260ivd, updating values of parameters of the first function so as to increase the probability that the first function will map belief states of the communication network node to changes in configuration of internal components of the communication network node that maximize the reward value predicted by the configuration model. Thus, the reward function with which the configuration model is combined may be used to generate the policy by providing reward values based on observed measures of performance. For example, a configuration change that results in increased network node throughput, may thus be rewarded with a high reward value. As will be described in more detail below, the first function may thus be updated accordingly to maximize the reward value predicted by the configuration model.

In some examples of the present disclosure various existing processes for solving POMDP models may be used to implement the steps of FIG. 2e. Examples of such processes include the point based SARSOP solver, Enumeration (Sondik '71, Monahan '82, White '91), Two Pass (Sondik '71), Witness (Littman '97, Cassandra '98), Incremental Pruning (Zhang and Lui '96, Cassandra, Littman and Zhang '97), Finite Grid—and instance of point-based value iteration (PBVI) (Cassandra '04)

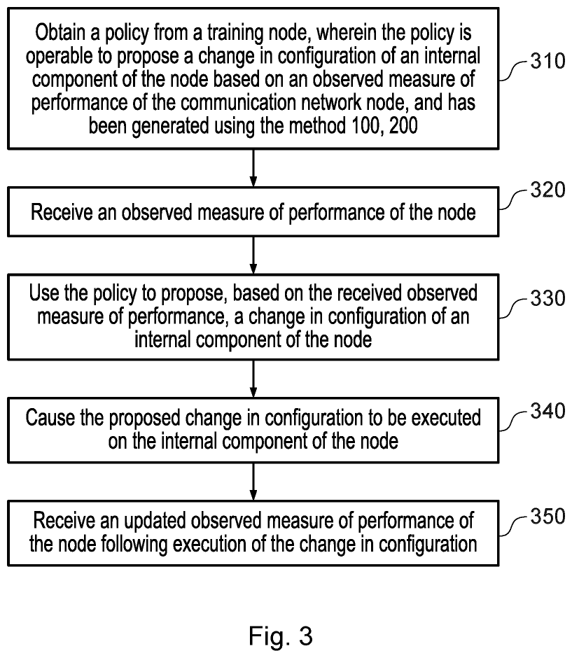

The methods 100 and 200 may be complemented by methods for using the generated policy to manage a communication network node. FIG. 3 is a flow chart illustrating process steps in a computer implemented method for using a policy to manage a configuration of internal components of a communication network node. In some examples, the policy may be generated using the method 100 or 200 described above. The method 300 is performed by a management node, which may comprise a physical or virtual node, and may be implemented in a computing device or server apparatus and/or in a virtualized environment, for example in a cloud, edge cloud or fog deployment. The management node may for example be implemented in a core network of the communication network. The management node may encompass multiple logical entities, as discussed in greater detail below, and may for example comprise a Virtualised Network Function (VNF).

The method 300 comprises, in step 310, obtaining the policy from a training node, the policy being operable to propose a change in configuration of an internal component of the communication network node based on an observed measure of performance of the communication network node. The method further comprises, in step 320, receiving an observed measure of performance of the communication network node and, in step 330, using the policy to propose, based on the received observed measure of performance, a change in configuration of an internal component of the communication network node. The method thus further comprises, in step 340, causing the proposed change in configuration to be executed on the internal component of the communication network node and, in step 350, receiving an updated observed measure of performance of the communication network node following execution of the change in configuration.

Thus, in some examples, a management node may receive a policy developed by a training node using a RL process, such as the RL process described above in methods 100 and 200. The management node may apply the policy to manage configuration of internal components of a communication network node by observing measures of performance of the node and using the policy to propose changes to the configuration of internal node components based on the observed measures of performance.

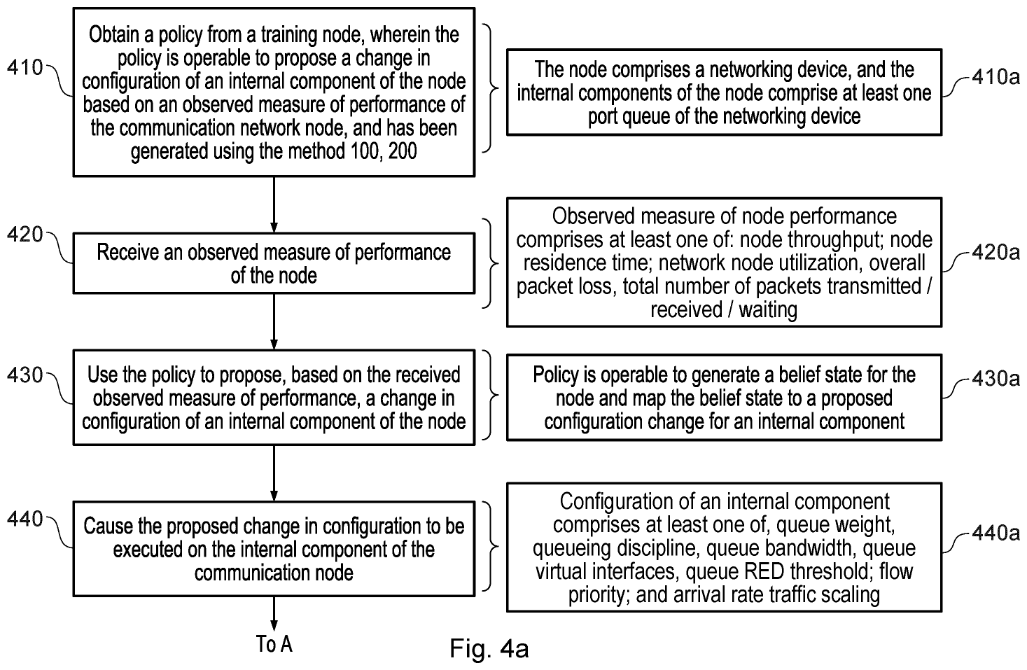

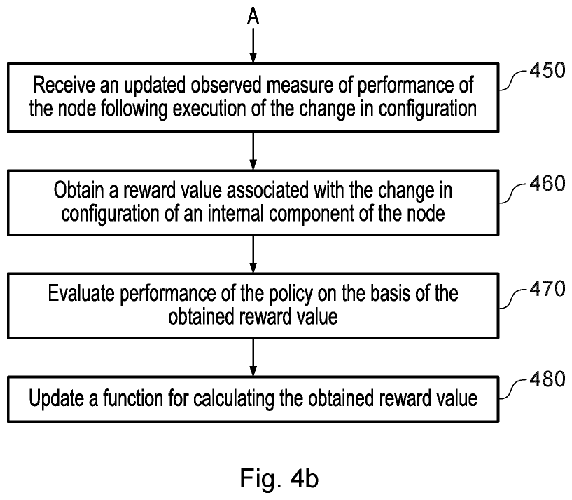

FIGS. 4a-b show a flow chart illustrating process steps in another example of a computer implemented method for using a policy to manage a configuration of internal components of a communication network node. The method 400 provides one example of how the steps of the method 300 may be implemented and supplemented to achieve the above discussed and additional functionality. As for the method 300, the method 400 is performed by a management node, which may comprise a physical or virtual node, and may be implemented in a computing device or server apparatus and/or in a virtualized environment, for example in a cloud, edge cloud or fog deployment.

Referring to FIG. 4a, the method 400 comprises, in step 410, obtaining a policy from a training node, wherein the policy is operable to propose a change in configuration of an internal component of the node based on an observed measure of performance of the communication network node, and has been generated using the method 100 and/or 200. As illustrated in step 410a, the node may comprise a networking device, and the internal components of the node may comprise at least one port queue of the networking device. In some examples, the networking device may comprise a router or a switch.

The method 400 further comprises, in step 420, receiving an observed measure of performance of the communication network node. As illustrated at 420a, the observed measure of node performance may comprise at least one of: communication network node throughput; communication network node residence time; network node utilization, overall packet loss, total number of packets transmitted; total number of packets received; and total number of packets waiting to be transmitted or received.

Referring still to FIG. 4a, the method comprises, in step 430, using the policy to propose, based on the received observed measure of performance, a change in configuration of an internal component of the communication network node. As illustrated, in step 430a, the policy is operable to generate a belief state for the communication network node and map the belief state of the communication network node to a proposed configuration change for an internal component of the communication network node. Additional discussion of how the policy may map the belief state to an action, and map observation, action, and previous belief state to an updated belief state, for example using first and second functions, is provided above with reference to the method 200. Referring again to FIG. 4a, the method further comprises, in step 440, causing the proposed change in configuration to be executed on the internal component of the communication network node. As illustrated in step 440a, the configuration of the internal component may comprise at least one of: queue weight; queueing discipline; queue bandwidth; queue virtual interfaces; queue Random Early Drop (RED) threshold; flow priority; and arrival rate traffic scaling.

Referring to FIG. 4b the method may further comprise, in step 450, receiving an updated observed measure of performance of the communication network node following execution of the change in configuration. In some examples, the management node may then use the policy to select a further change in configuration of the communication network node based on the updated observed measure of performance.

Referring to FIG. 4b the method may further comprise, in step 460, obtaining a reward value associated with the change in configuration of an internal component of the communication network node; and, in step 470, evaluating performance of the policy on the basis of the obtained reward value. In some examples, the policy may be continually updated using a RL process. The policy may be continually evaluated based on reward values generated by the reward function based on the observed performance metrics generated in response to configuration changes proposed by the policy. In this way, the policy may be continually updated in response to dynamic network changes. Referring again to FIG. 4b, the method may further comprise, in step 480, updating a function for calculating the obtained reward value. In some examples, a reward function may thus be updated in response to changing network parameters. For example, the reward value associated with an increased communication network node throughput may be increased in a situation where the network requires increased bandwidth.

As discussed above, the methods 100 and 200 may be performed by a training node, and the present disclosure provides a training node that is adapted to perform any or all of the steps of the above discussed methods. The training node may be a physical or virtual node, and may for example comprise a virtualised function that is running in a cloud, edge cloud or fog deployment. The training node may for example comprise or be instantiated in any part of a logical core network node, network management centre, network operations centre, Radio Access node etc. Any such communication network node may itself be divided between several logical and/or physical functions, and any one or more parts of the management node may be instantiated in one or more logical or physical functions of a communication network node.

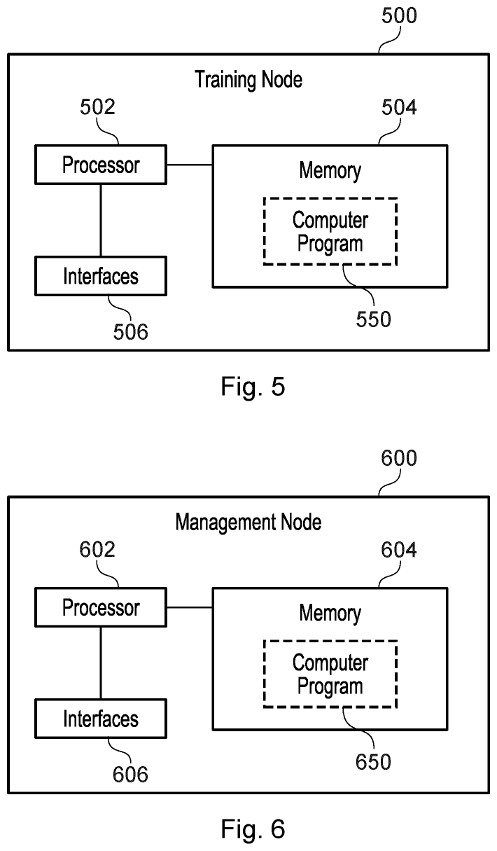

FIG. 5 is a block diagram illustrating an example training node 500 which may implement the method 100 and/or 200, as illustrated in FIGS. 1 and 2a-2d, according to examples of the present disclosure, for example on receipt of suitable instructions from a computer program 550. Referring to FIG. 5, the training node 500 comprises a processor or processing circuitry 502, and may comprise a memory 504 and interfaces 506. The processing circuitry 502 is operable to perform some or all of the steps of the method 100 and/or 200 as discussed above with reference to FIGS. 1 and 2a-2d. The memory 504 may contain instructions executable by the processing circuitry 502 such that the training node 500 is operable to perform some or all of the steps of the method 100 and/or 200, as illustrated in FIGS. 1 and 2a-2d. The instructions may also include instructions for executing one or more telecommunications and/or data communications protocols. The instructions may be stored in the form of the computer program 550. In some examples, the processor or processing circuitry 502 may include one or more microprocessors or microcontrollers, as well as other digital hardware, which may include digital signal processors (DSPs), special-purpose digital logic, etc. The processor or processing circuitry 502 may be implemented by any type of integrated circuit, such as an Application Specific Integrated Circuit (ASIC), Field Programmable Gate Array (FPGA) etc. The memory 504 may include one or several types of memory suitable for the processor, such as read-only memory (ROM), random-access memory, cache memory, flash memory devices, optical storage devices, solid state disk, hard disk drive etc. The training node 500 may further comprise interfaces 506 which may be operable to facilitate communication with a management node, and/or with other communication network nodes over suitable communication channels.

As discussed above, the methods 300 and 400 may be performed by a management node, and the present disclosure provides a management node that is adapted to perform any or all of the steps of the above discussed methods. The management node may be a physical or virtual node, and may for example comprise a virtualised function that is running in a cloud, edge cloud or fog deployment. The management node may for example comprise or be instantiated in any part of a logical core network node, network management centre, network operations centre, Radio Access node etc. Any such communication network node may itself be divided between several logical and/or physical functions, and any one or more parts of the management node may be instantiated in one or more logical or physical functions of a communication network node.

FIG. 6 is a block diagram illustrating an example management node 600 which may implement the method 300 and/or 400, as illustrated in FIGS. 3 and 4, according to examples of the present disclosure, for example on receipt of suitable instructions from a computer program 650. Referring to FIG. 6, the management node 600 comprises a processor or processing circuitry 602, and may comprise a memory 604 and interfaces 606. The processing circuitry 602 is operable to perform some or all of the steps of the methods 300 and/or 400 as discussed above with reference to FIGS. 3 and 4. The memory 604 may contain instructions executable by the processing circuitry 602 such that the management node 600 is operable to perform some or all of the steps of the method 300 and/or 400 as discussed above with reference to FIGS. 3 and 4. The instructions may also include instructions for executing one or more telecommunications and/or data communications protocols. The instructions may be stored in the form of the computer program 650. In some examples, the processor or processing circuitry 602 may include one or more microprocessors or microcontrollers, as well as other digital hardware, which may include digital signal processors (DSPs), special-purpose digital logic, etc. The processor or processing circuitry 602 may be implemented by any type of integrated circuit, such as an Application Specific Integrated Circuit (ASIC), Field Programmable Gate Array (FPGA) etc. The memory 604 may include one or several types of memory suitable for the processor, such as read-only memory (ROM), random-access memory, cache memory, flash memory devices, optical storage devices, solid state disk, hard disk drive etc. The management node 600 may further comprise interfaces 606 which may be operable to facilitate communication with a training node and/or with other communication network nodes over suitable communication channels.

FIGS. 1 to 4b discussed above provide an overview of methods which may be performed according to different examples of the present disclosure. These methods may be performed by a training node and a management node, as illustrated in FIGS. 5 and 6, respectively. There now follows a detailed discussion of how different process steps illustrated in FIGS. 1 to 4b and discussed above may be implemented. The functionality and implementation detail described below is discussed for generating a policy for managing a configuration of internal components of a router. It will be appreciated, however, that this is merely one example implementation of a communication network node to which examples of the present disclosure may be applied. The functionality described below may also be implemented for any other suitable communication network node.

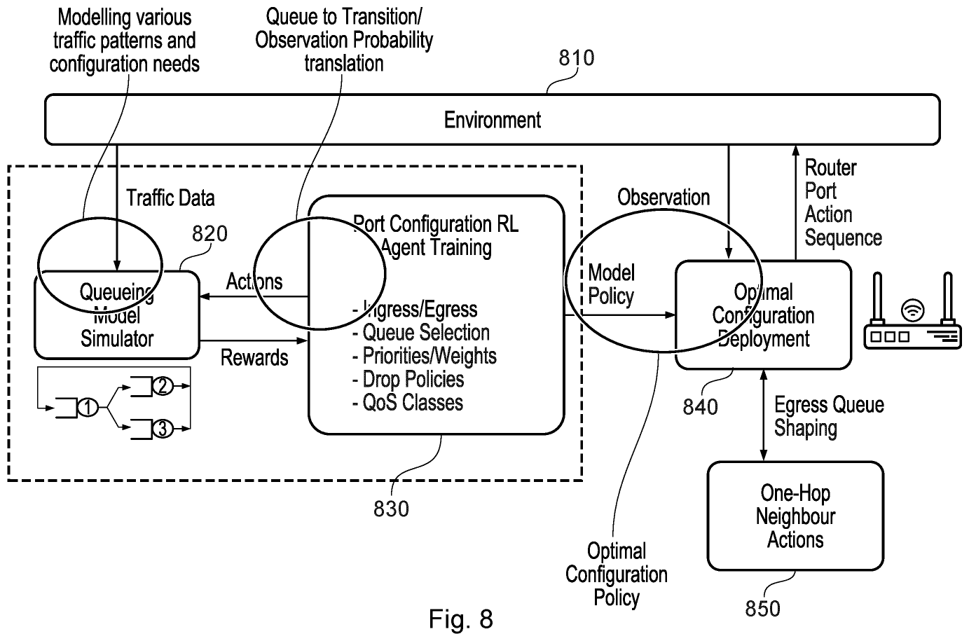

FIG. 8 illustrates an example architecture 800 for generating a policy for managing a configuration of internal components of a communication network node, according to the present disclosure. Architecture 800 comprises an environment 810, such as a network or part of a network, within which a network node in the form of a router is deployed. The architecture 800 further comprises a queuing model simulator 820, which is configured to generate a model of the router traffic and its queuing ports, described in more detail below. The model generated by simulator 820 can simulate how changes to the internal configuration of the router can affect observable performance metrics of the router, such as router throughput, residence time, etc.

The architecture 800 further comprises a reinforcement learning (RL) training agent 830, which is configured to generate a partially observable Markov decision process (POMDP) based on the queuing model. As will be described in more detail below, the agent transforms the actions and observations of the model into a set of conditional probabilities, which can enable the training agent to generate a belief of the operational state of the router based on the observation generated from a particular action. The POMDP can thus provide the probability of the router undergoing a state and observation transition in response to a particular action. For example, the POMDP may provide a probability of a utilization state of a queue of the router transitioning from a low utilization state to a higher utilization state in response to a particular action. The training agent 830 is configured to generate a policy for managing internal components of the router by solving the POMDP model. The training agent 830 is configured to apply actions in the form of configuration changes to the internal components of the router to the POMDP model, and observe the change sin performance of the router, referred to as observations, that result from the applied actions. Such actions can include changes to classes of flows and their priorities, bandwidth, latency, queue length, input and output queueing models, number of virtual interfaces per port and rate capacities, policing and shaping of flows, packet drop policies and percentages, and QoS specifications and trade-offs. The agent 830 is configured to receive rewards based on the observations that result in actions, which actions may be beneficial to the router and/or network. In this way, the agent may generate a policy to control the internal configurations of the router, for example configurations of the router port queue, in response to dynamically changing network conditions and requirements so as to maximise expected future reward. The agent may be provided with various inputs from the simulator 820, which represent dynamically changing traffic patterns and network conditions.

Architecture 800 further comprises a configuration deployment 840 in which the policy generated by the training agent 830 is applied to a router or environment 810 for further training and tuning of the policy. The performance of the policy may be assessed against a suitable reward structure and further adjustments to the policy may be made according to further rewards received based on observations obtained from environment 810 during application of the policy. The policy may also take into account one-hop neighbour actions 850.

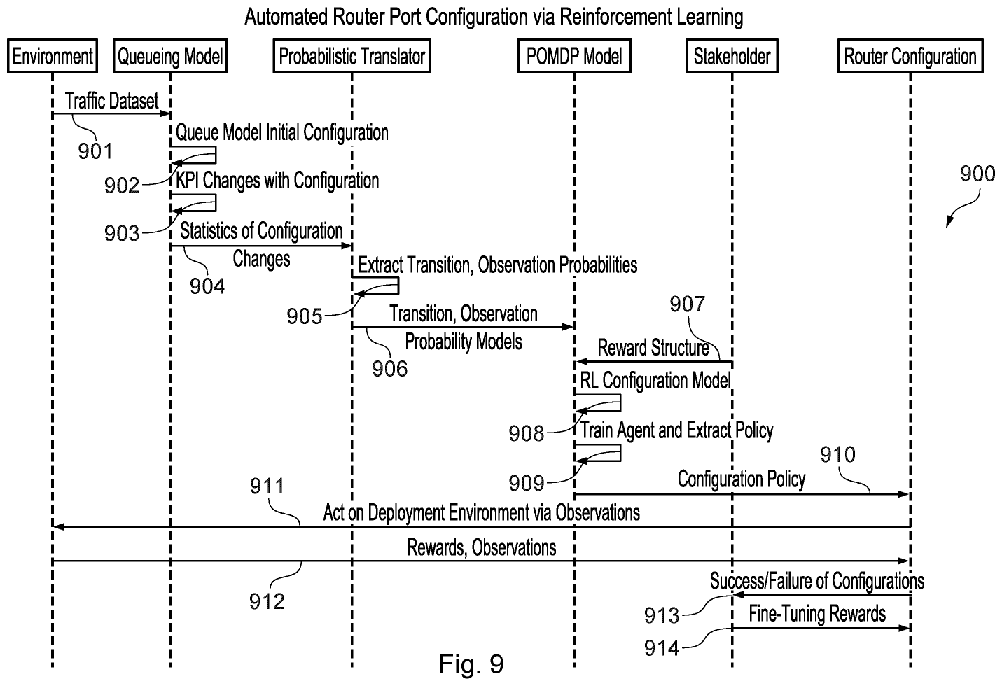

FIG. 9 is a signalling diagram illustrating example message exchange between components of a system for generating a policy for managing a configuration of internal components of a communication network node, such as a router. The system includes an environment and a stakeholder such as a network operator. The system also comprises a training node and a management node. The training node is implemented across several logical components, illustrated as a queueing model simulator, probabilistic translator, and POMDP unit. The management node is implemented as a router configuration module.

Referring to FIG. 9, the queuing model simulator receives at 901 a router traffic dataset from the environment. The traffic dataset may comprise data representative of the flow of data packets through the router under a set of network conditions.

At 902, the queuing model simulator generates a model of the internal components of the router. The model may simulate how traffic is processed through the internal components (queues) of the router under a given set of network conditions. At 903, the queuing simulator changes the configuration of internal components of the router in the generated model and observes how the traffic flow and performance metrics of the router change in response to the configuration changes. In some examples, the performance metrics may be key performance indicators (KPIs), whose observed values are referred to as ‘observations’. The simulator constructs a first data set illustrating how different configuration changes of the router affect the KPIs of the router and states of its internal components. Data statistics of the configuration changes and resulting changes in operational state and performance measures are provided by the simulator to the probabilistic translator at 904.

At 905, the probabilistic translator extracts conditional probabilities of operational state and observable KPI transitions in response to actions that may be performed to change the internal configuration of the router. The probabilistic translator translates the statistical data from the simulator into conditional probabilities. The conditional probabilities provide a probability distribution that illustrates a likelihood that a certain action will result in a particular operational state change and KPI change.

At 906, the probabilistic translator provides the conditional probability models to the PODMP model unit. The POMDP model unit also receives, at 907, a reward structure from the stake holder such as a network operator or customer. At 908, the POMDP model unit combines the reward structure with the probability models to form a POMDP model of the router. The POMDP model is operable to map a current belief state of the router and an observation to a proposed action that will maximise future reward, and to map an initial belief state, proposed action, and observation to an updated belief state. The reward structure may be configured such that a policy is generated to satisfy a particular network requirement, such as a QoS requirement. At 909, the POMDP model unit perform RL training to train a policy that will select actions that maximise future reward.

At 910, the generated policy is provided to the router configuration module for application. At 911, the policy is used to select actions for execution in the environment based oi observations. At 912, observations and rewards are generated as a consequence of the executed actions. For example, the actions dictated by the policy may result in KPI changes which will be returned to the configuration module with rewards based on the reward structure. The reward structure may thus determine which KPI changes are most important for a given set of network requirements.

At 913, the stakeholder is provided with information assess the performance of the policy based on the observations and rewards generated from the environment. At 914, the stakeholder may adjust the reward structure based on the performance of the policy and/or in response to changing requirements of the network.

FIG. 9 described above provides an overview of how examples of the methods 100, 200, 300, 400 may be implemented in a signalling exchange between components of training and management nodes. Additional discussion of how the individual method steps may be implemented, together with illustrative examples, is provided below. The discussion uses the example of a communication network node in the form of a router. In order to provide additional context to the discussion, there now follows a more detailed explanation of router configuration and operation.

A router typically has two types of network element components, which are organised onto separate processing planes. A control plane maintains a routing table that lists which route should be used to forward a data packet, and through which physical interface connection. The control plane control may dictate which route to use to forward a packet based on internal pre-configured directives, often termed ‘static routes’, or by learning routes dynamically using a routing protocol. The control plane logic thus builds a forwarding information base (FIB), which is used by the forwarding plane. In the forwarding plane, the router forwards data packets between incoming and outgoing interface connections. The router forwards the packets to the correct network type by matching information contained in the packet header to entries supplied in the FIB by the control plane.

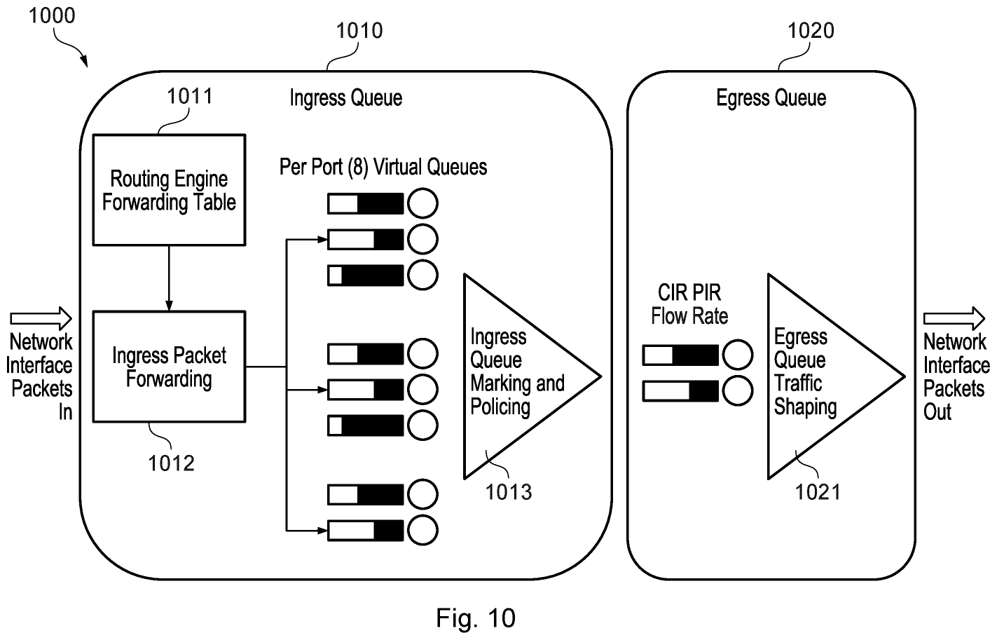

FIG. 10 illustrates a schematic example of a router 1000 illustrating the principle of operation of the router ingress queue 1010 and egress queue 1020. Router interfaces have ingress (inbound) queues 1010 and egress (outbound) queues 1020. An ingress queue 1010 stores packets until the router CPU can forward the data to the appropriate interface. An egress queue 1020 stores packets until the router can serialize the data onto a physical wire for further transmission.

When a packet arrives at a router it enters ingress queue 1010. The packet is assigned an internal priority level and an internal drop precedence. Priority and precedence are determined by a default ingress class map, which maps to the packet's protocol headers. The arriving packet is then subjected to a policing policy configured on the ingress queue 1010. The packet is further subjected to a classification filter where packets belonging to a particular class can be rate-limited or marked. Rate limits can be assigned to different classes of packet, where conforming traffic is marked ‘green’, exceeding traffic marked ‘yellow’ and violating traffic marked ‘red’. Violating traffic may also be dropped immediately instead of being marked red. The decision of whether to mark violating traffic as red or drop it immediately is dependent on the commands configured by the policy. Packets can further be processed by having their drop precedence values modified if they are not dropped.

After processing at the ingress queue 1010, the packet passes to the egress queue 1020, where the packet undergoes egress scheduling. Egress scheduling assigns each outgoing packet to an egress queue based on the destination circuit and internal priority settings. Egress queues have associated scheduling parameters, such as rates, depths, and relative weights. A packet can be dropped when queues back up over a configured discard threshold or because of a Random Early Drop (RED) parameter setting. Once assigned on to a queue, the packet may be output from the router 1000 for further transmission.

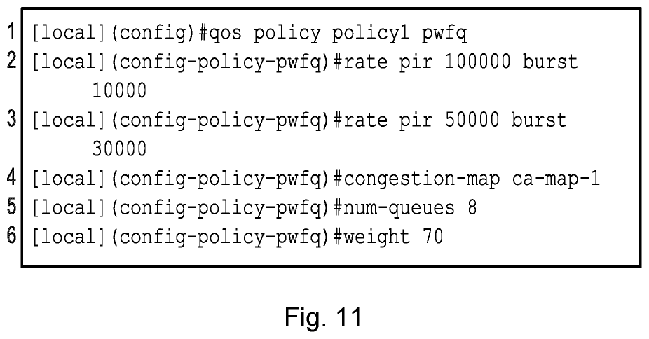

Both ingress and egress queues within a router port may be configured to operate on different queue types. Depending on the combination of flows and QoS requirements, a queuing model may be used to control the flow of packets. These models can include: First-In First-Out (FIFO), Priority Queuing (PQ), Fair Queue (FQ), Weighted Fair Queuing (WFQ) and Priority WFQ (PWFQ). In most commercial routers the PWFQ model is used. FIG. 11 illustrates an example of a PWFQ policy.

Policing and shaping of packets are two methods that can help reduce traffic congestion. These methods involve continuously measuring the rate at which data is sent or received. Policing applies a hard limit to the rate at which traffic arrives or leaves an interface. Packets are either dropped (hard policing) or re-classified (soft policing) if they do not conform to the constraints. Shaping also defines a limit to the rate at which traffic can be transmitted, but unlike policing, shaping acts on traffic that has already been granted access to a queue and is awaiting access to transmission resources. Shaping can therefore help ease traffic congestion when a neighbouring network is policing or is slower in accepting traffic.

One well known packet policing policy is two rate three colour marking. This policy bases the packet marking on the Committed Information Rate (CIR) and the Peak Information Rate (PIR). The CIR is the average traffic rate that a customer is allowed to send into a network. The PIR is the maximum average sending rate for a customer. Traffic bursts that exceed CIR but remain under PIR are thus allowed in the network, but are marked for more aggressive discarding.

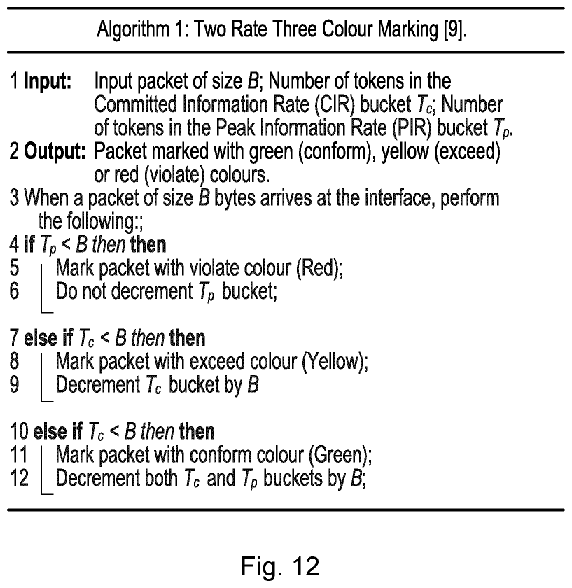

FIG. 12 illustrates Algorithm 1, which may be used to enforce the two rate three colour marking policy. As illustrated, Algorithm 1 marks packets with one of three possible actions: a conform action (Green), an exceed action (Yellow), and an optional violate action (Red). Packets are assigned a yellow or red mark if the tokens in the CIR or PIR buckets for a customer are exceeded. Exceeding packets (Yellow) can be sent with a decreased priority, and violating packets (Red) can be marked for aggressive dropping. In some examples, customers may specify these actions.

A router scheduler maintains an average queue length for each queue of the router that is configured for Random Early Drop (RED). When a packet is enqueued, the current queue length, to which the packet is enqueued, is weighted into the average queue length based on the average-length exponent in the drop profile. When the average queue length exceeds the minimum threshold, RED procedure begins randomly dropping packets. While the average queue length increases towards the maximum threshold, RED drops packets with increasing frequency, up to a maximum drop probability. When the average queue length exceeds the maximum drop threshold, all packets are dropped.

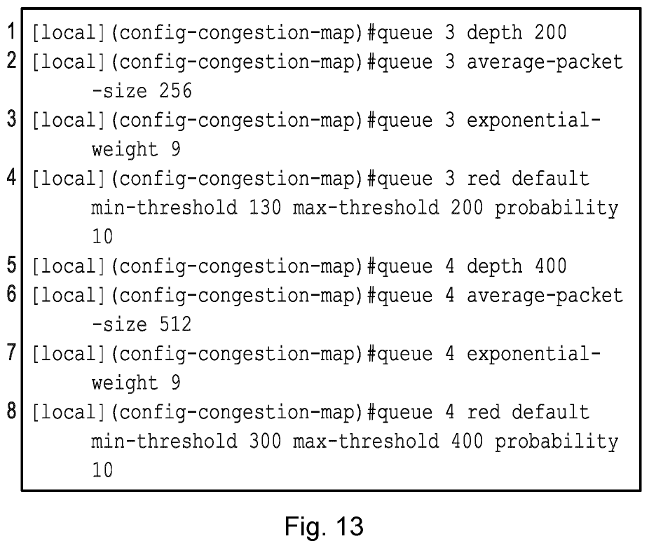

FIG. 13 illustrates an example profile of dropping packets for congestion avoidance. The queue depth is used along with the queue average packet size to calculate the effective queue depth. The minimum threshold sets the RED queue occupancy below which packets are not dropped.

Application of methods of the present disclosure to router management in a 5G network slicing scenario

Slicing has been introduced in 5G networks to meet diverse requirements of ultra-reliable low latency communication (URLLC), massive machine to machine communication (MMtC) and enhanced mobile broadband (eMBB). In some examples, various slice requirements may be affected by configurations of a router port. In this case, the transport layer may not be able to meet service level agreements (SLA) because of congestion at a particular port, which may be detected by a diagnosis tool. Sub-optimum configuration of a router port can consequently lead to a bottleneck, thus detrimentally affecting network slicing. Examples of the present disclosure can be used to dynamically and automatically reconfigure the relevant port to alleviate such a bottleneck.

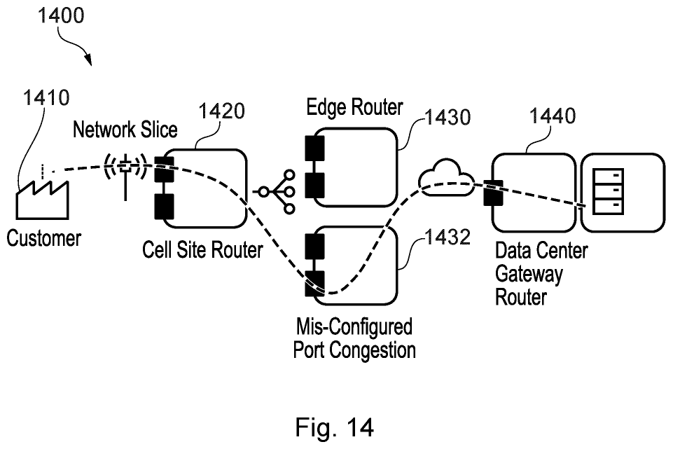

FIG. 14 illustrates a network scenario 1400 in which a misconfigured router port has led to congestion. A customer 1410 transmits a data packet over a network slice via a cell site router 1420. The packet passes to edge router 1430 via a misconfigured router port 1432, which causes congestion on the route to data center gateway router 1440. The congestion may result in the network slice being unable to meet service level QoS objectives.

A solution to this congestion problem, once identified, may be to re-route the traffic to another port. However, the misconfiguration may be a systematic problem that would entail repeated changes to the slice. Traffic may be re-routed via overlay components, which involves setting up new virtual functions, migrating resources and components, which may not be needed in all cases.

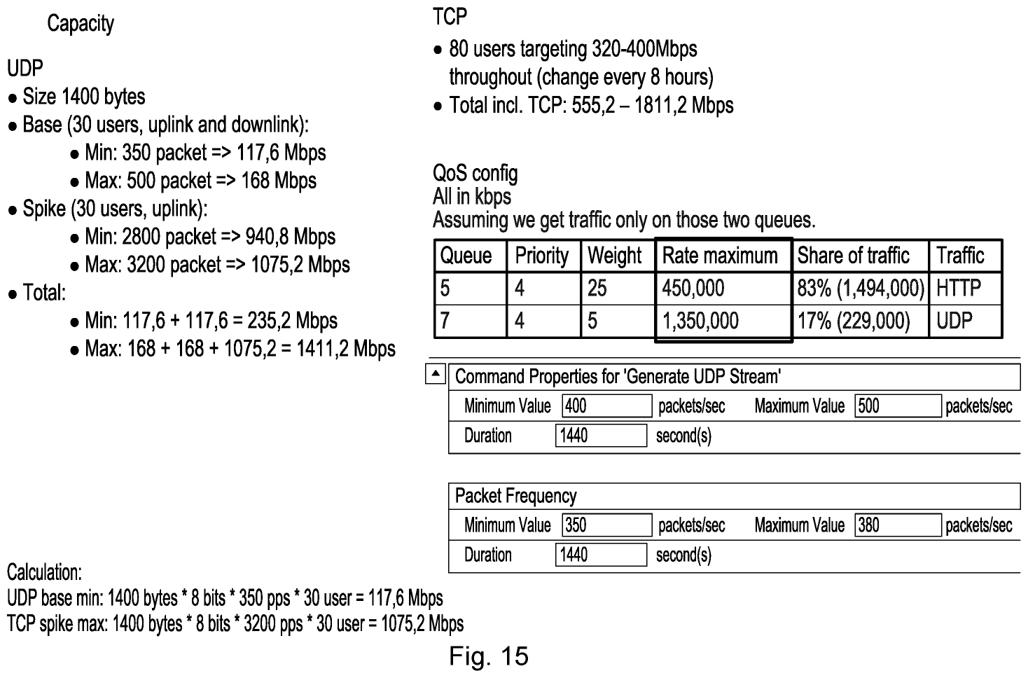

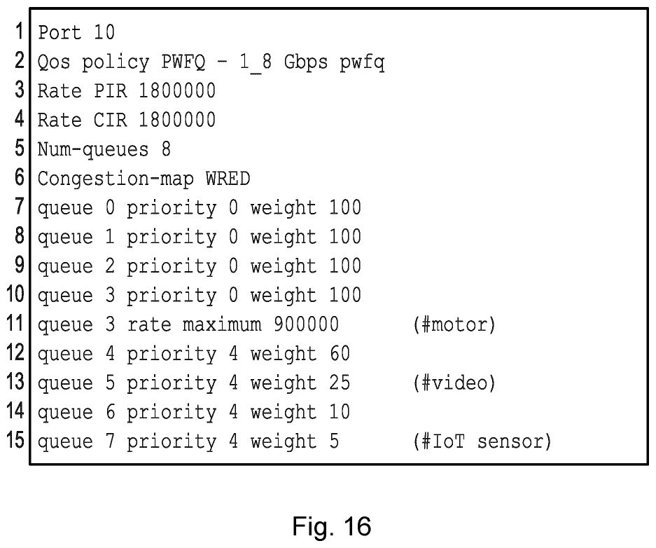

FIG. 15 illustrates flows of traffic that the edge router of scenario 1400 in FIG. 14 may act upon. In one example the router may comprise an Ericsson 6675 router. The traffic flows comprise 60 UDP users and 80 TCP users. FIG. 16 illustrates a port configuration for router 1400 used to direct the traffic flows of FIG. 15.

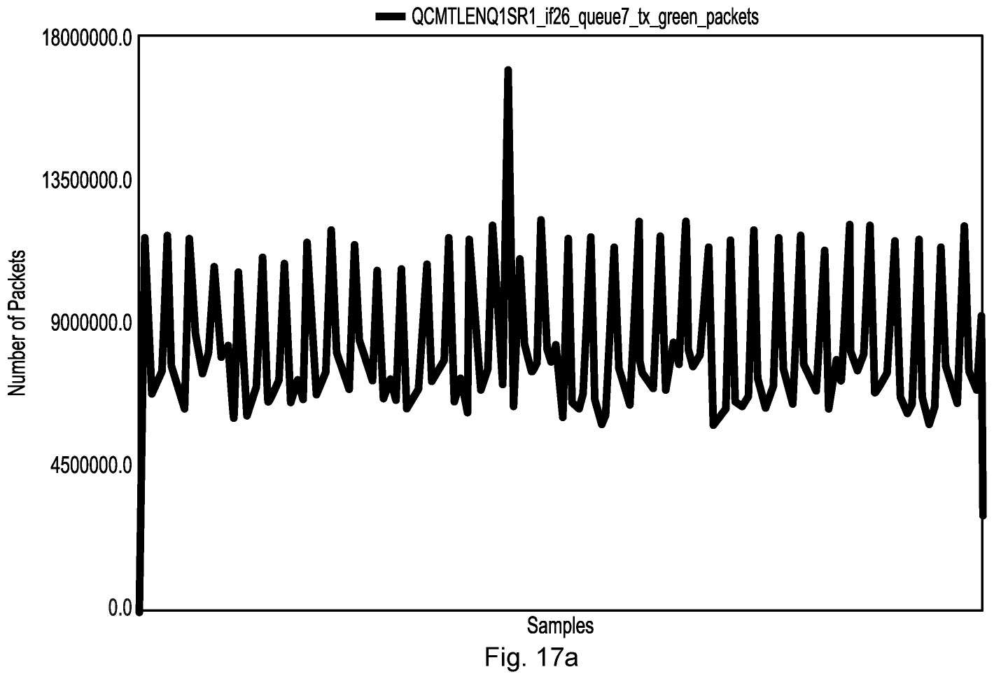

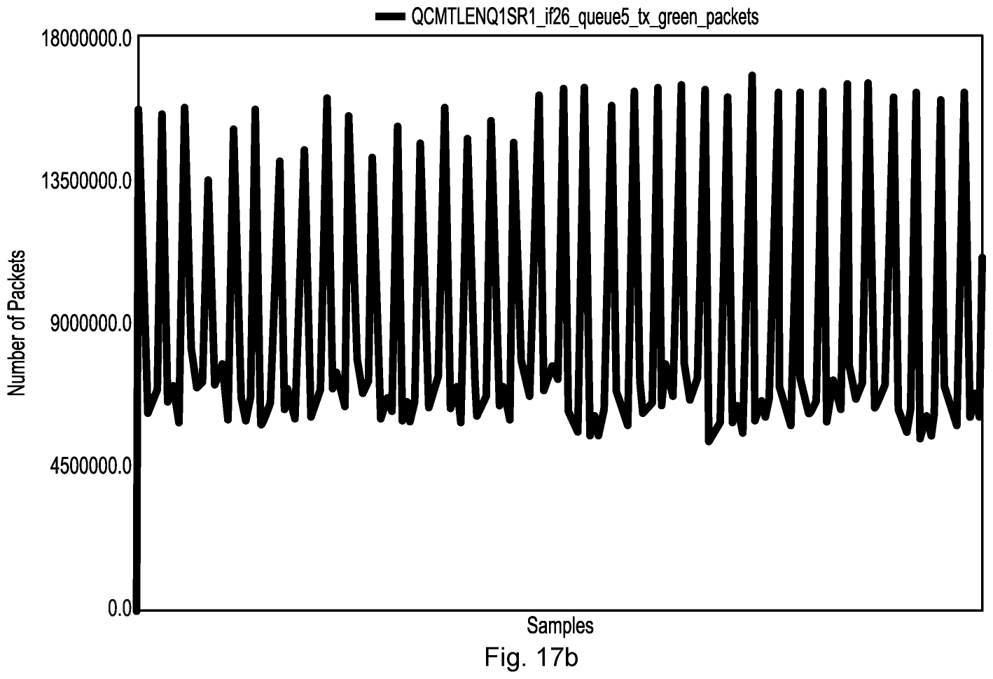

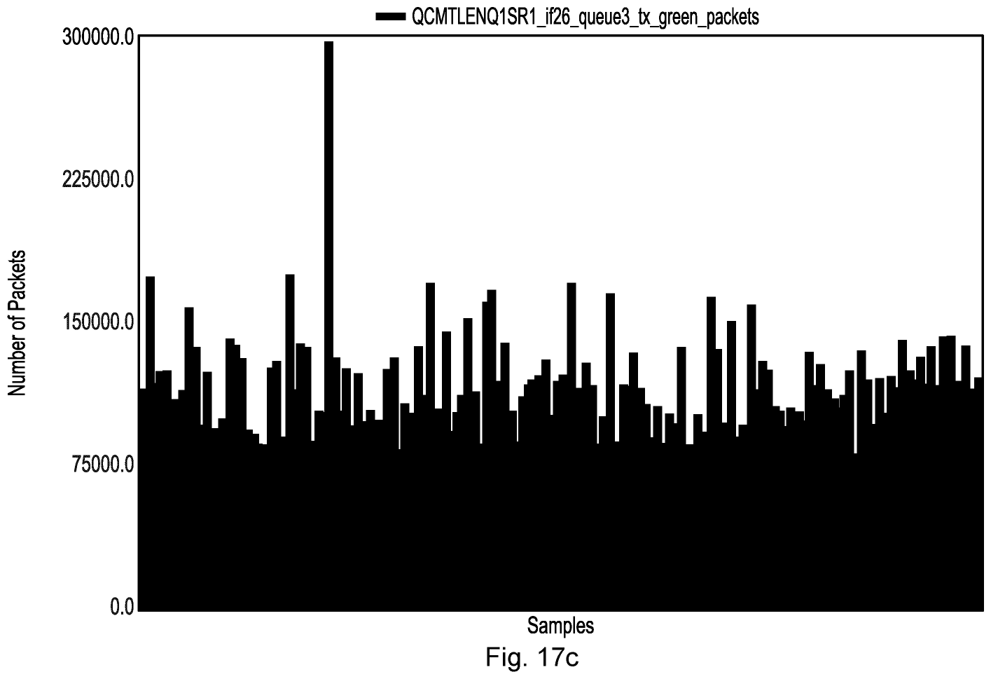

FIGS. 17a-c illustrate examples of traffic generated using the queue port configuration of FIG. 16. Owing to the priority and weight settings, queue 7 and queue 5, illustrated in FIG. 17a and FIG. 17 b respectively, receive the bulk of the traffic, which causes increased congestion in those queues. Conventionally, reconfiguring the router to alleviate such problems is an expert-driven process, which involves an expert analysing the problem to reconfigure the router appropriately. As discussed above, such a solution has several drawbacks.

Examples of the present disclosure may provide a solution that can alleviate traffic bottlenecks and congestion by being able to automatically re-configure a router port queue configuration on-the-fly.

The presently discussed example uses a POMDP model, which allows for optimal decision making in environments which are only partially observable to a training agent. A POMDP may be particularly suited for deciding on an optimal configuration for a router in a given set of network conditions, because the utilization, length, and residency time of each queue of a router is not observable. As described above with reference to FIG. 7, a policy trained using a POMDP model may propose adjustments to a configuration of a router based on a belief of an operational state of a router, which state may be formed from operational states of the individual router queues, with each queue state based on at least one of queue utilization, queue length, queue residence time, etc. The POMDP trained policy may thus observe changes in the performance metrics of the router, which may be termed ‘observations’, and receive rewards based on these observations. Based on the observations and on the rewards, the POMDP may update its belief of the operational state of the router and propose changes to the configuration of the router queues to optimise expected reward.

The POMDP model specifies operational states of the router, actions that may be executed on the router, and observations that may be made of router performance and which may be relevant for router port configuration. The operational states of the router are comprised of the unobservable states of the individual queues, which states may be based on any one or more of the utilization, length and residency time of the queue, all of which can impact the marking of an incoming packet. Example operational states, actions, and observations for the router of the present example are given below. It will be appreciated that the examples given below are not exhaustive, even for the particular example situation under consideration.

### Router States:

S1: Q0-3_low_Q4_low_Q5_low_Q7_low
S2: Q0-3_low_Q4_low_Q5_low_Q7_high
S3: Q0-3_low_Q4_low_Q5_high_Q7_low
S4: Q0-3_low_Q4_low_Q5_high_Q7_high

Each state S1 to S4 is formed from the individual states of each queue (Q0 to Q7). Each queue state (low or high) is based on one or more queue metrics that are compared to a threshold in order to generate the queue state.

### Actions:

Q5_weight_increase
Q5_weight_decrease
Q5_bandwidth_limit_decrease
Q5_bandwidth_limit_increase
Q5_interface_increase
Q5_interface_decrease
Q5_PFWQ_FIFO
Q5_RED_packet_drop_high

Each action is a change in one or more configurable parameters for one or more of the queues. In the illustrated list of actions, all actions relate to configuration of the queue Q5.

### Observations:

system_residence_time_increase
system_residence_time_decrease
system_throughput_increase
system_throughput_decrease
system_queue_drop_increase
system_queue_drop_decrease

Each observation is a change in an observable performance parameter for the router.

In order to develop a POMDP model that can form a belief of an operational state of a router that accurately corresponds to the operational state, an accurate and detailed simulation of a router queue port configuration may be generated.

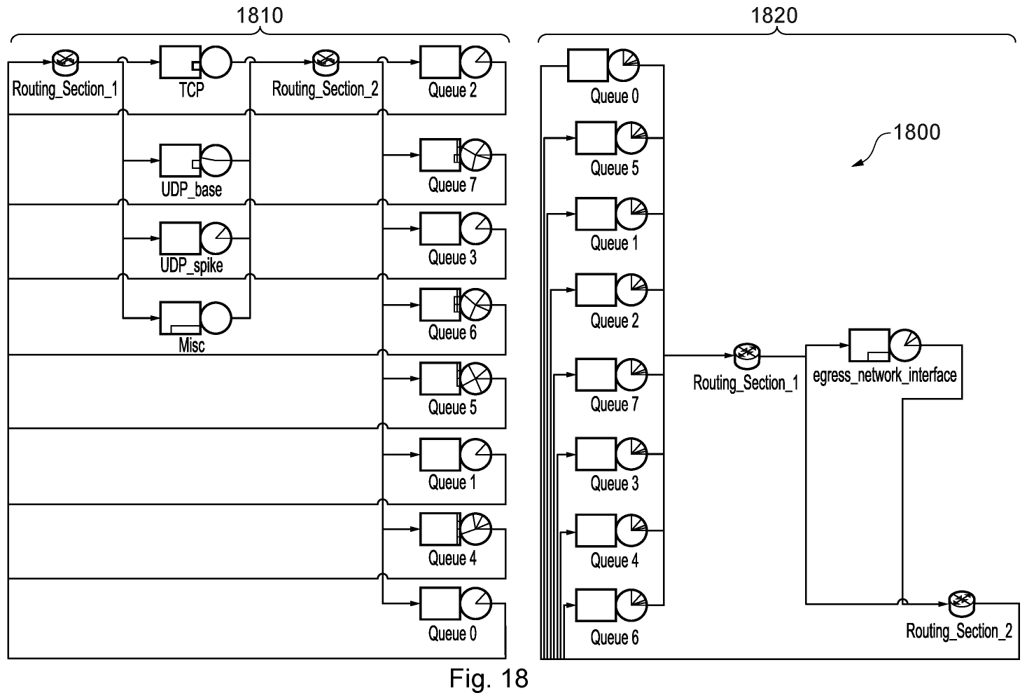

FIG. 18 illustrates an example of a simulation 1800 of a router queue port configuration. Simulation 1800 comprises an ingress queue simulation 1810 and an egress queue simulation 1820. The example simulation 1800 was generated using the Java Modeling Tools ‘JMT’ found in the paper entitled “JMT: performance engineering tools for system modeling” by M. Bertoli, G. Casale, G. Serazzi, ACM SIGMETRICS Performance Evaluation Review, Volume 36 Issue 4, New York, US, March 2009, 10-15, ACM press. However, it will be appreciated that other programs may be used to generate a simulation of a queue port of a router.

FIG. 18 represents the router port ingress and egress closed queuing models in JMT. The simulation 1800 was developed for multiple classes of customer flows including UDP, TCP and VoIP. The simulation 1800 makes use of the workload intensity parameter N, which takes into account the average number of jobs i.e. customers in flow execution. The simulation 1800 further takes into account the priorities for processing each class of flows and the arrival rate of packets at the queues, which is specified by a Poisson process with the Service Time, which is the processing time per visit of a station. In some examples, the generation of simulation 1800 is one example implementation of the steps 120 and 220 of generating a model of the communication network node, described above.

The simulation 1800 is a robust representation of router queue port activity and provides insights into various performance indices, such as:
1. Number of Customers: At the station level, this refers to both customers waiting in the queue and those receiving service.
2. Residence Time (of a station): total time spent at a station by a customer, both queueing and receiving service, considering all the visits at the station performed during its complete execution.
3. Drop Rate (of a station or of the entire system): rate at which the customers are dropped from a station or a region for the occurrence of a constraint (e.g., maximum capacity of a queue, maximum number of customers in a region).
4. Throughput (of a station or of the entire system): at the station level this refers to the rate at which customers depart from a station, i.e., the number of requests completed in a time unit. At the system level this refers to the rate at which customers depart from the system. These values are described per each class of customer.
5. Utilization (of a station): percentage of time a station is used (i.e., busy) evaluated over all the simulation run. The utilization ranges from 0 (0%), when the station is always idle, to a maximum of 1 (100%), when the station is constantly busy servicing customers for the entire simulation run.

Simulation 1800 is consequently operable to simulate how changes in configuration of internal components of a router result in observed changes in performance of the router. To be used for training a POMDP model, the observable configurations and observations of the simulation 1800 may be translated into probabilities, which give a likelihood of a particular observation occurring following a particular change in configuration of the router.

In one example, probabilities may be generated for a utilization of a queue to transition from one discrete value to another based on a change to an internal component of the router.

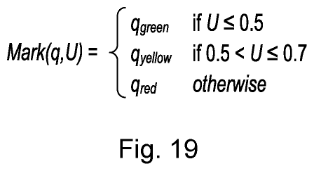

FIG. 19 illustrates a process for mapping queue utilization levels in individual queues to a queue state for that queue. In the example of FIG. 19, colours are used for the queue states, with possible queue states being green, yellow, and red. As illustrated, for a given queue q, a queue utilization value U of less than 50% is mapped to a green queue state, a queue utilization of between 50% and 70% is mapped to a yellow queue state, and a queue utilization for all other utilization values is mapped to a red queue state. For different possible configuration changes and input traffic flows, output utilization values for individual queues can be mapped to queue states using the process of FIG. 19. This may form part of using the model of the communication network node to generate a first data set, as described above with reference to steps 130 and 230 of methods 100 and 200.

From the observed changes in the utilization of a queue, conditional probabilities may be derived of change of utilization state between q_{green}, q_{yellow} and q_{red}. For instance, the probability of change from state q_{yellow} to q_{green} for a given change in a configuration of internal components of the router may be generated. This probability may be combined with probabilities of other queue state changes to generate a probability of an operational state change for the router.

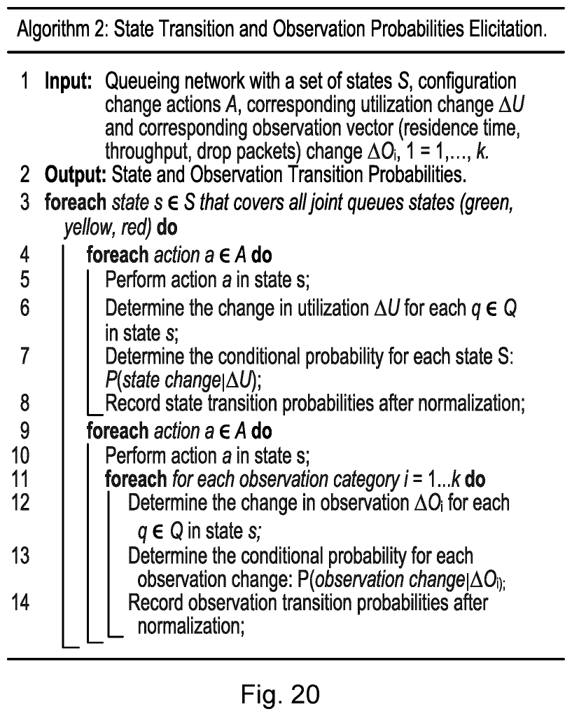

FIG. 20 illustrates an example Algorithm 2, which may be used to transform the observable parameters and router configurations of simulation 1800 into a set of conditional transition probabilities, using the queue utilization based queue states described with reference to FIG. 19. Algorithm 2 is an example implementation of steps 140, 240 as described above and illustrated for example in FIGS. 2c and 2d.

Referring to FIG. 20, the algorithm receive a plurality of inputs, which include: a set of operational states S of the queueing network of the router; configuration change actions A, which change the configuration of internal components of the router; corresponding queue utilization changes AU resulting from the actions; and corresponding changes in observations AO resulting from the actions. The algorithm generates operational state and observation transition probabilities based on the inputs.

Referring again to FIG. 20, the algorithm determines a conditional probability for an operational state of the router to undergo a transition based on an action. For each state, and for each possible action within that state, the algorithm involves performing the action, determining the change in utilization of each queue as a consequence of the action, and then, based on the individual queue state changes implied by the change in utilization, determining a probability that the router will transition to each possible operational state of the router as a consequence of the action. The state transition probabilities for the action and then normalized and recorded. This process is repeated for all possible actions within a state and for all possible states. For example, an operational state of a queue, Q1, may be green i.e. Q1_{green}. An action of decreasing a weight applied to Q1 i.e. weight_decrease produces an observed utilization increase of 5%. Using the threshold for mapping utilization to queue state, this results in conditional transition probabilities of P(Q1_{green}|weight_decrease in Q1_green)=0.9 and P(Q1_{yellow}|weight_decrease in Q1_green)=0.1. This is because, in only 10% of cases with utilization in the range [0, 0.5] (equivalent to green state), a 0.05 increase will result in utilization in range [0.51, 0.7] (equivalent to yellow state). This transition probability can be combined with transition probabilities for other queues to assemble the transition probabilities for the router as a whole (the operational state of the router being formed from the individual queue states of its queues).

In a similar manner, transition probabilities for transitions in observations are also generated by Algorithm 2. Referring again to FIG. 20, for each state, and for each possible action within that state, the algorithm involves performing the action, and then, for each observation category, (for example, router throughput), the change to this observation, e.g. router throughput increase, as a consequence of the action is determined. A conditional probability is then determined for the observation to undergo all possible changes e.g. throughput increase and throughput decrease, based on the action. The conditional probabilities are recorded after normalization.

The conditional probabilities generated by Algorithm 2 can express the operational state of a router in probabilistic form. The conditional probabilities can further express how actions may affect the operational state of the router and the likelihood of these actions resulting in operational state and observation transitions based on the actions.

Policies are typically mapped to configuration commands found in dedicated network providers, such as Ericsson, JuneOS and Cisco router operating systems. However, in some examples, the policy may also be controlled by a software defined network (SDN) controller. As the SDN controller has the purview of all routers in the network, the SDN controller may identify and reconfigure specific router ports with the following example application programming interface (API) calls:
Q5_weight_increase is mapped to the following API call for configuration change:
[local](config}#qos policy policy1 pwfq
[local](config-policy-pwfq}#queue 5 exponential-weight 20

Q5_bandwidth_limit_decrease is mapped to the following API call for configuration change:
[local](config}#qos policy policy1 pwfq
[local](config-policy-pwfq}#queue 5 rate pir 50000
[local](config-policy-pwfq}#queue 5 rate cir 50000

The now follows aa presentation of evaluation of example methods according to the present disclosure for generating policies for management of ingress queues, egress queues and traffic change.

### Example 1: Ingress Queues

Examples of the present disclosure were evaluated on ingress queues of a router. The simulated ingress queues 1810 of simulation 1800 described above with reference to FIG. 18 were used for the present example.

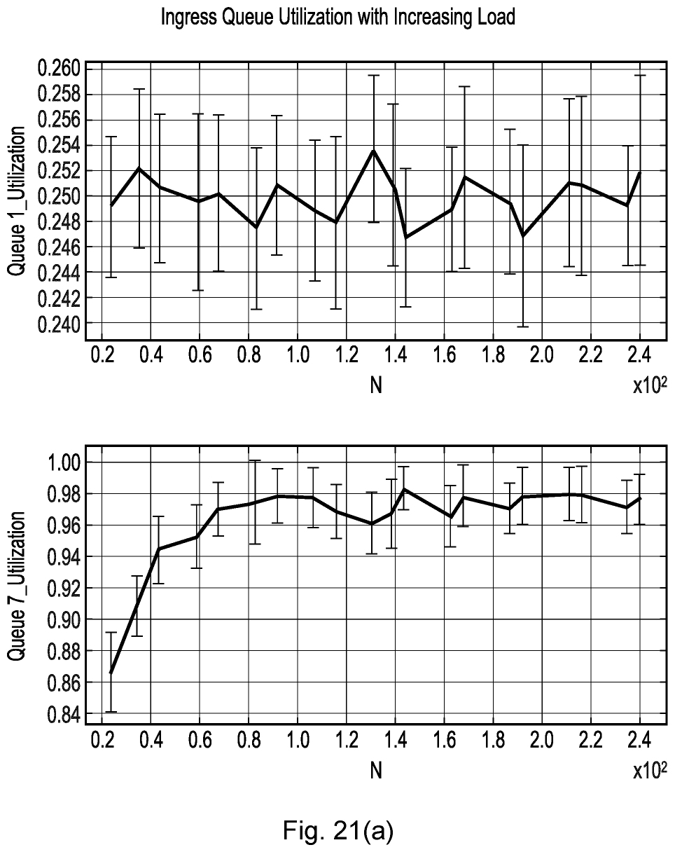

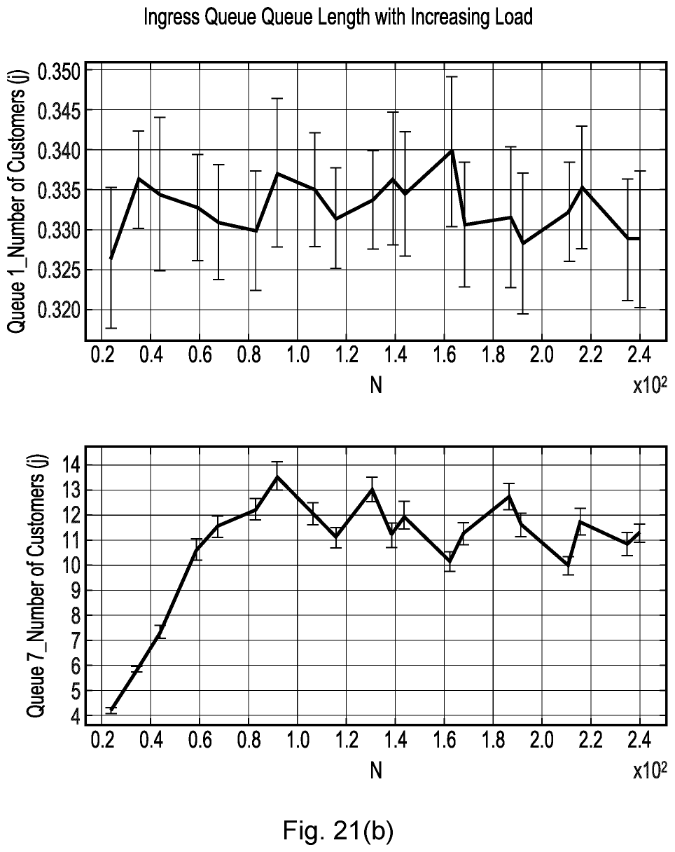

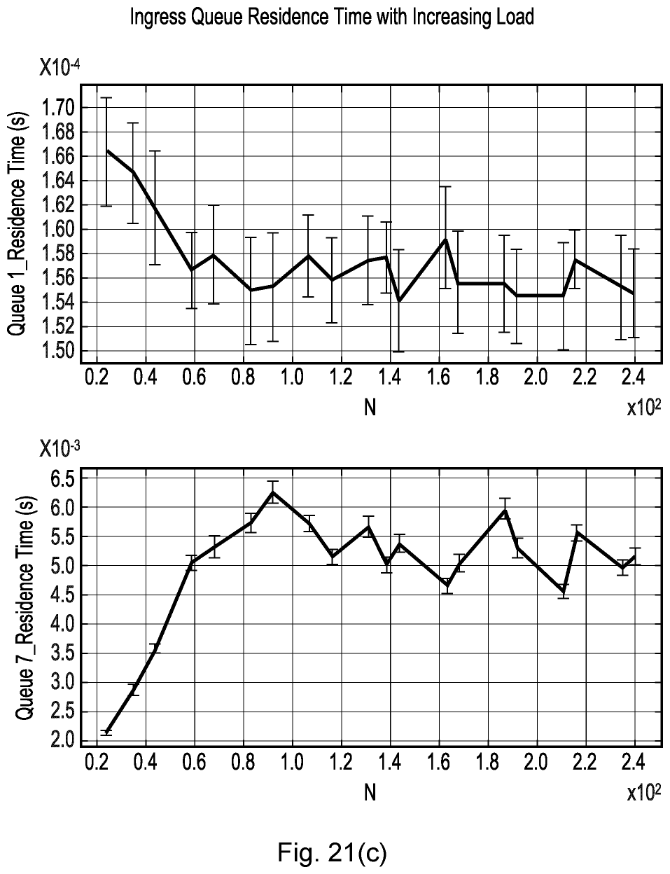

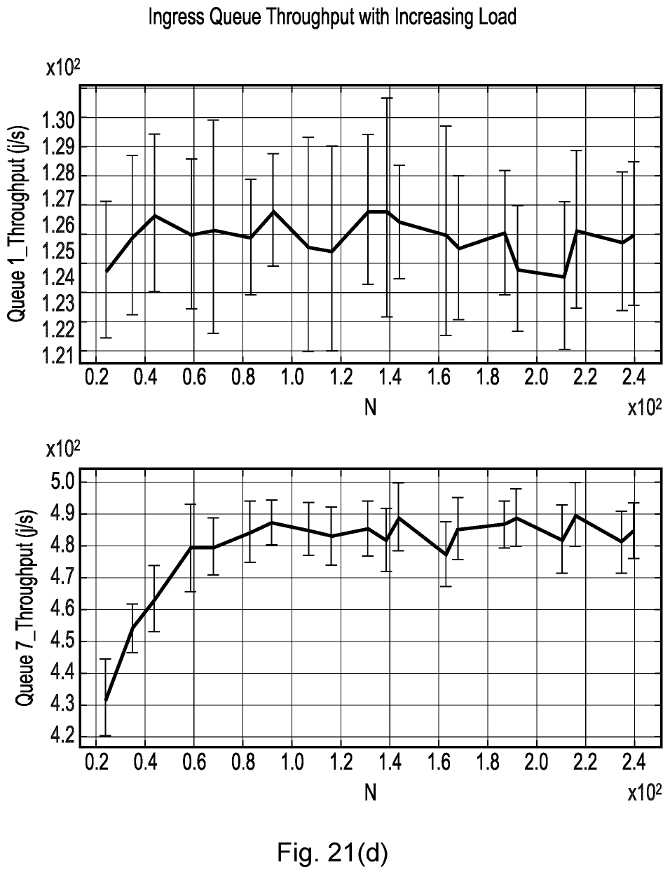

FIGS. 21a-d illustrate the output of the queueing simulation for queues 1810 with the misconfigured router. FIGS. 21a-d illustrate the utilization, queue length, residence times and throughput with increasing load for queue 1 and queue 7, allowing for comparison. As illustrated, queue 7 exhibits increased utilization, queue length and residence times with increasing load, despite queue 1 (and ques 1, 2 and 3) having lower than usual utilization. The aim of a policy to be generated according to the present disclosure is to alleviate this imbalance between the queues, and so improve overall router performance, while maintaining priorities of individual flows within the system.

In order to generate the policy, the method first involves collecting from the router model statistics of changes in observed performance metrics of the router as a result of internal component configuration changes to the router.

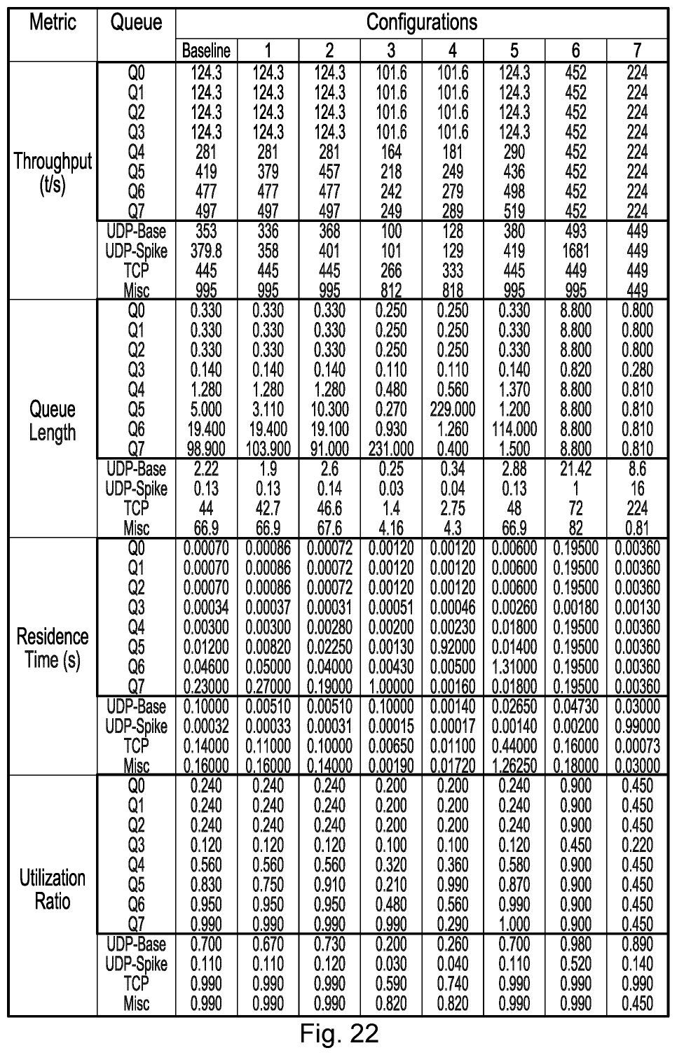

The JMT simulator described above was used to study the improvements and deteriorations in performance metrics caused by configuration changes to internal components of the router. FIG. 22 illustrates the changes in observed performance metrics of the router in response to seven configuration changes. The seven configuration changes were:
1. Queue 5 weight increase by 10
2. Queue 5 weight decrease by 10
3. Queue 5 bandwidth increase by 50%
4. Queue 5 bandwidth decrease by 50%
5. Queue 5, Queue 7 virtual interfaces increased by 1
6. Queue change from PWFQ to FCFS
7. Queue RED packet drop increase

It will be appreciated that whilst the present example has focused on changing configuration of one queue, this example can similarly be extended to combinations of various ingress queue configurations.

The steady state metrics for configuration changes as presented in FIG. 22 can be input to Algorithm 2, described above with reference to FIG. 20, in order to generate state and observation transition probabilities. A snippet of the POMDP file format is shown below.

### #Transition Probabilities

T: Q5_weight_increase
1.0 0.0 0.0 0.0 0.0 0.0 0.0 0.0 0.0 0.0
0.0 1.0 0.0 0.0 0.0 0.0 0.0 0.0 0.0 0.0
0.26 0.0 0.74 0.0 0.0 0.0 0.0 0.0 0.0 0.0
0.0 0.26 0.0 0.74 0.0 0.0 0.0 0.0 0.0 0.0
0.0 0.0 0.0 0.0 1.0 0.0 0.0 0.0 0.0 0.0
0.0 0.0 0.0 0.0 0.0 1.0 0.0 0.0 0.0 0.0
0.0 0.0 0.0 0.0 0.26 0.0 0.74 0.0 0.0 0.0
0.0 0.0 0.0 0.0 0.0 0.26 0.0 0.74 0.0 0.0
0.1 0.0 0.0 0.0 0.0 0.0 0.0 0.0 0.9 0.0
0.0 0.0 0.0 0.0 0.0 0.0 0.0 0.0 0.0 1.0

### #Observations

O: Q5_weight_increase:*: Q5_residence_time_increase 0.0
O: Q5_weight_increase:*: Q5_residence_time_decrease 0.125
O: Q5_weight_increase:*: Q5_throughput_increase 0.0
O: Q5_weight_increase:*: Q5_throughput_decrease 0.125

### #Rewards

R: Q5_weight_increase: Q0-3_green_Q4_green_Q5_green_Q7_green:*:*−10
R: Q5_weight_increase: Q0-3_green_Q4_green_Q5_green_Q7_red:*:*−10
R: Q5_weight_increase: Q0-3_green_Q4_green_Q5_red_Q7_green:*:*20
R: Q5_weight_increase: Q0-3_green_Q4_green_Q5_red_Q7_red:*:*20
R: Q5_weight_increase: Q0-3_green_Q4_red_Q5_green_Q7_green:*:*−10

The same observation is mapped to multiple possible underlying utilization states (green, yellow, red) of the individual queues. Routers do not expose individual queue utilization, but instead expose overall performance metrics such as throughput, packet drop rates and latencies. An RL model makes use of these observations to infer the appropriate configurations that would alleviate a queue bottleneck. A POMDP model has uncertainty built in to estimate the appropriate configuration as discussed above. In another example the POMDP can be converted to a conventional MDP by mapping each observation to a particular state of the router or queue

The PODMP model may be subjected to an RL process known as a ‘SARSOP solver’, which is presented in the paper entitled “SARSOP: Efficient point-based POMDP planning by approximating optimally reachable belief spaces” by H. Kurniawati, D. Hsu, and W. S. Lee, In Proc. Robotics: Science and Systems, 2008.

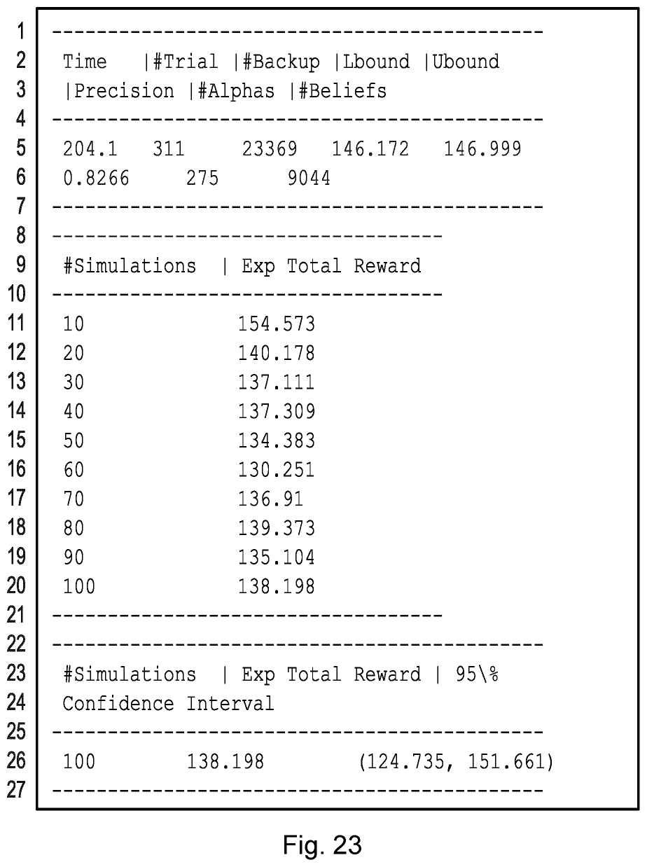

The SARSOP solver can be used to generate a policy that can appropriately reconfigure the router. The SARSOP solver is paired with a suitable reward function, configured to reward improvements in observable router measures of performance, such as throughput, residence times and packet drop rates etc. FIG. 23 illustrates rewards that are generated by the SARSOP solver applying actions to the POMDP model.

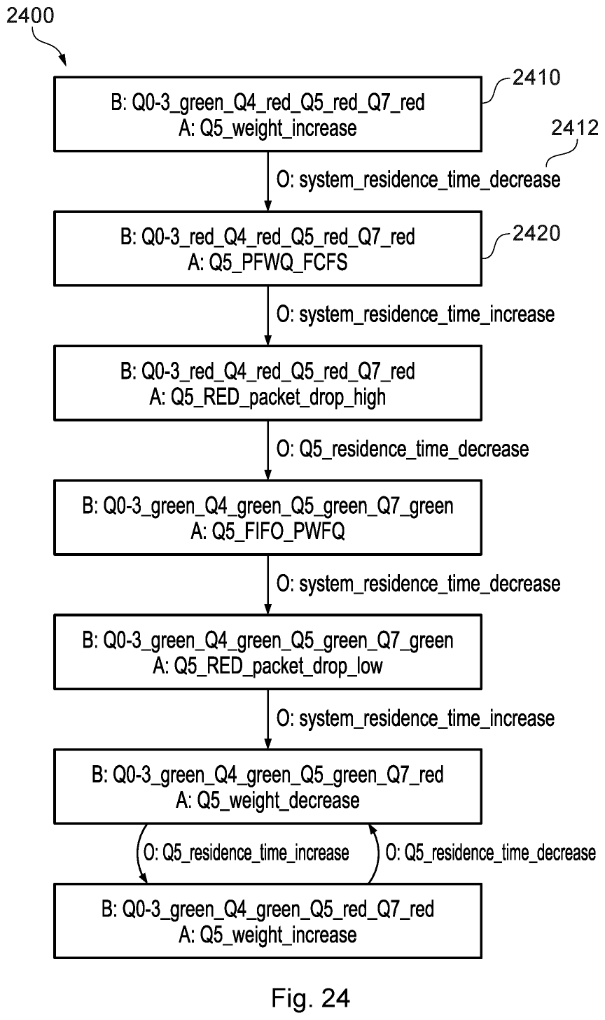

FIG. 24 illustrates a policy graph 2400 of a policy generated by the SARSOP solver with a simulation output of 1000 Monte Carlo runs. The policy graph 2400 illustrates a first belief B of the operational state of the router, which comprises the queue utilization states of queues Q0-3, Q4, Q5 and Q7 illustrated in step 2410. Step 2410 also comprises an action A that is to be applied to the router, which comprises a change to an internal configuration of the router of increasing the weight of Q5.

The action applied in step 2410 results in the observation O 2412 that the router residence time decreases. The belief B of the router is consequently updated, as illustrated in step 2420. Based on the observation 2412, the belief is updated such that the belief of the utilization of Q0-3 is updated from green to red, as illustrated in step 2420. Based on this updated belief, a further action is proposed, which is a change in the queue protocol of Q5 from PFWQ to FCFS, as illustrated in step 2420. The policy graph continues to propose actions to take based on the previous observation and on the updated belief in order to optimally configure the router.

Once the policy is generated, it may be applied to a router, or to a model such as simulation 1800 described above, to observe improvements in the router performance.

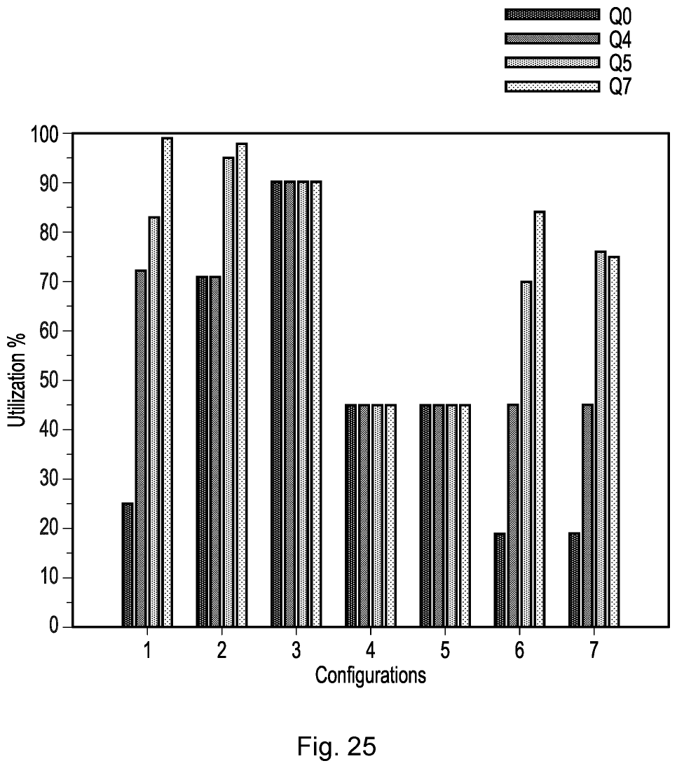

FIG. 25 illustrates the utilization of queues Q0, Q4, Q5 and Q7, in response to seven consecutive actions (configuration changes) applied to queues of the router. The policy was applied to the router until steady state observations were reached. Q5 and Q7 of the initial configuration have a utilization greater than 80%. After successive policy actions, all the queue utilizations are brought below the 80% level. However, in other examples, traffic policing could be altered such that the queue utilization for all queues is brought below any suitable utilization value. Thus, examples of the present disclosure generate a policy that can alleviate a bottleneck at a router ingress queue.

### Example 2: Egress Queues

Examples of the present disclosure were also evaluated on egress queues of a router. The simulated egress queues 1820 of simulation 1800 described above with reference to FIG. 18 were used for the present example. It is also important to perform effective shaping of egress packet queues in order to prevent packet drops at the output of routers.

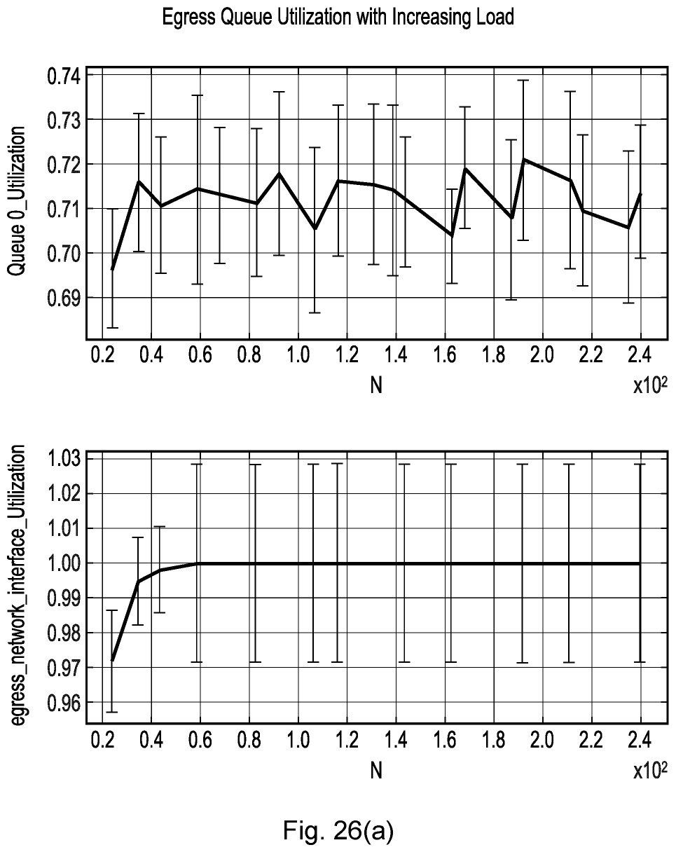

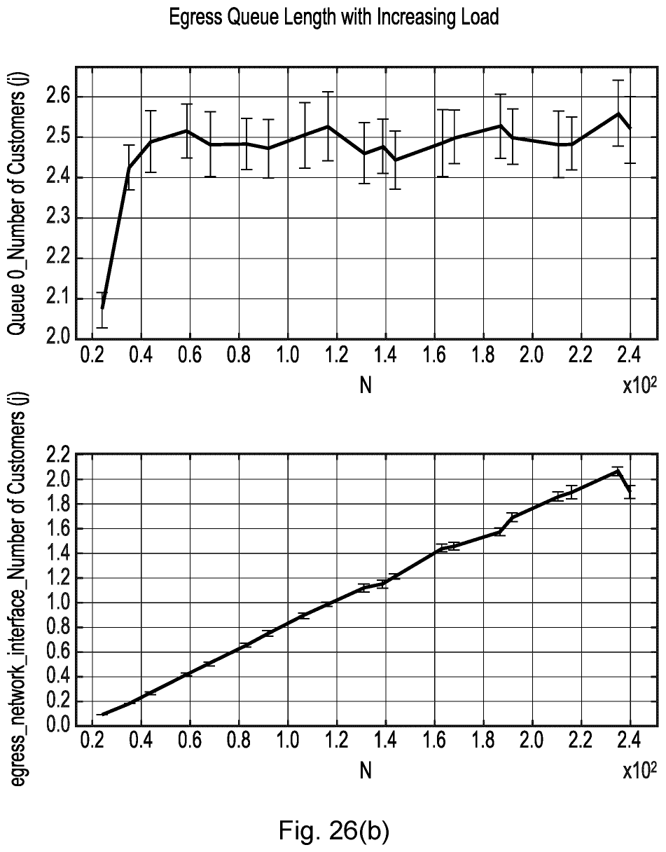

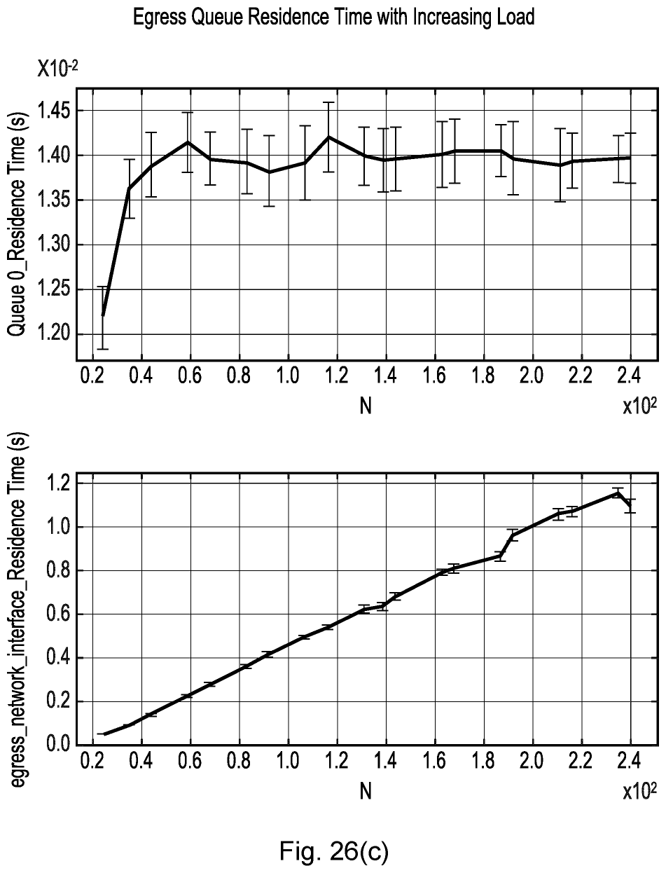

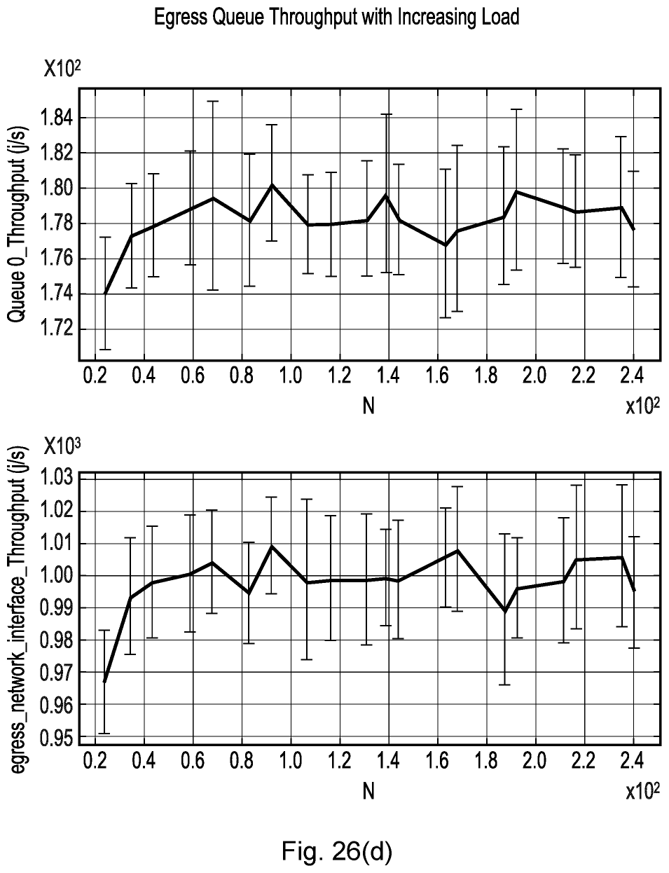

FIGS. 26a-d illustrate the output of the simulator 1800 for the egress queues 1820 of with an initialized queue configuration. FIGS. 26a-d illustrate the utilization, queue length, residence times and throughput for Queue 0 and the egress network interface of the router. As illustrated in FIGS. 26b and 26c, the egress network queue length and residence time increase rapidly with the egress queues reaching bottleneck while queue 0 (and queues 1 to 7) still have capacity.

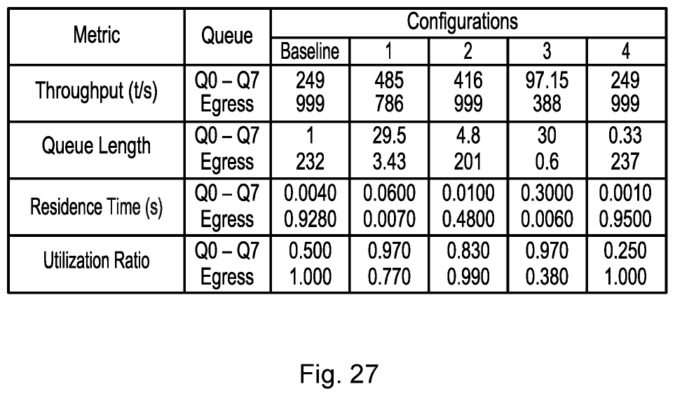

The JMT simulator described above was again used to study the improvements and deteriorations in performance metrics caused by configuration changes to internal components of the router. FIG. 27 illustrates the changes in observed performance metrics on the egress queues of the router in response to four configuration changes. The four configuration changes were:
1. Egress queue input routing percentage decrease by 20%
2. Egress queue input routing percentage decrease by 20%
3. Egress queue Bandwidth limit increase by 50%
4. Egress queue Bandwidth limit decrease by 50%

The statistics provided by the configuration changes were again translated to observation and state transition probabilities by the POMDP model. The SARSOP solver was then applied to the POMDP model with a suitable reward function to generate a policy to optimally configure the egress queues of the router.

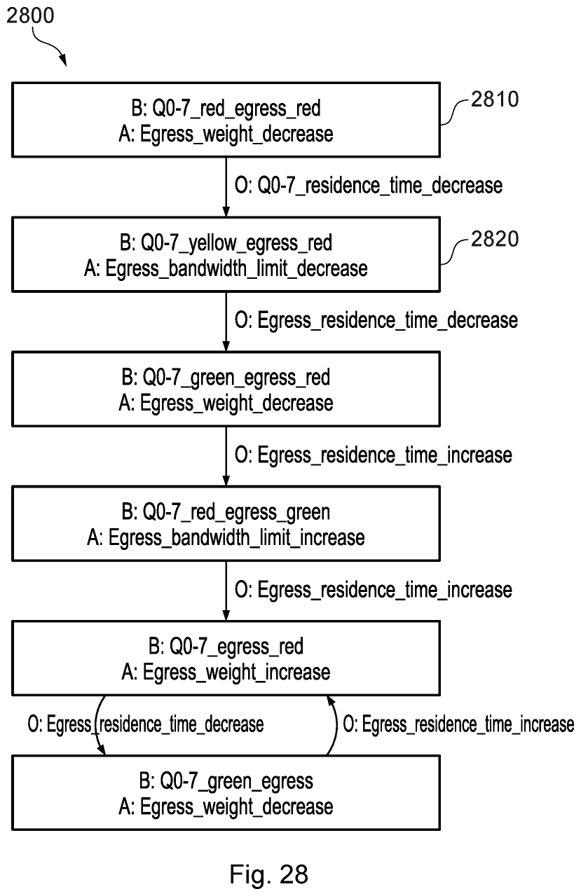

FIG. 28 illustrates a policy graph 2800 of a policy generated by the SARSOP solver, which illustrates a series of policy actions, which may be implemented with similar functionality to the policy graph of FIG. 25. The policy graph 2800 was generated using the Monte Carlo runs as presented below:

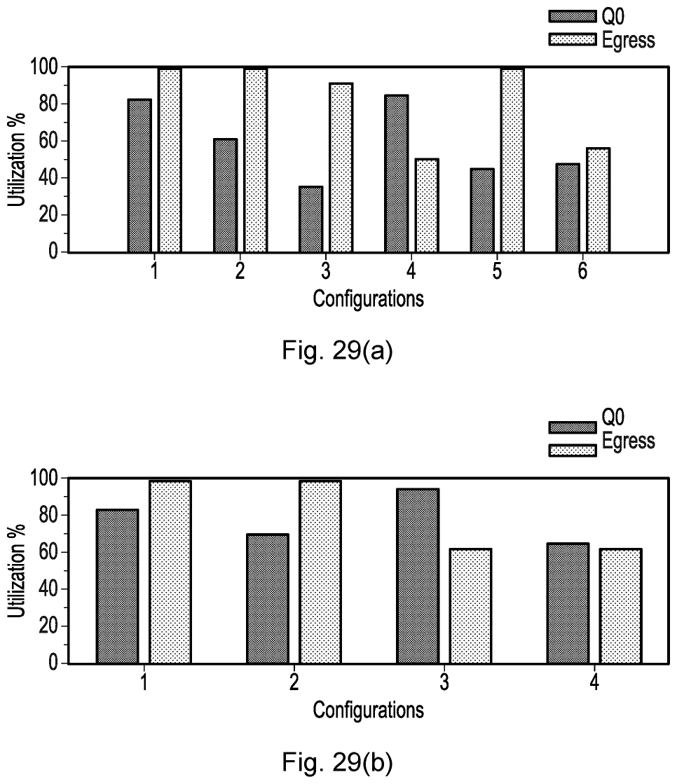

FIG. 29a illustrates the utilization of queue Q0 and the egress network interface in response to each configuration change from following the policy in FIG. 28. As illustrated, the configuration changes illustrate that the utilization of each queue reduces compared to the initial configuration. In particular, the utilization of Q0 and the egress network interface decreases to below 50%, which corresponds to the ‘green’ operational state.

FIG. 29b illustrates the results of generating a policy using the SARSOP solver, with a change to the reward function to reward changes for one-hop router configurations. In some examples, a one-hop router configuration may be useful in cases where the egress queue from one router may cause bottlenecks in subsequent routers by deploying excessive traffic into the network. This situation may thus be mitigated for by adjusting the reward function accordingly.

### Example 3: Traffic Change

Examples of the present disclosure may also reconfigure a router in response to changes in network traffic patterns.

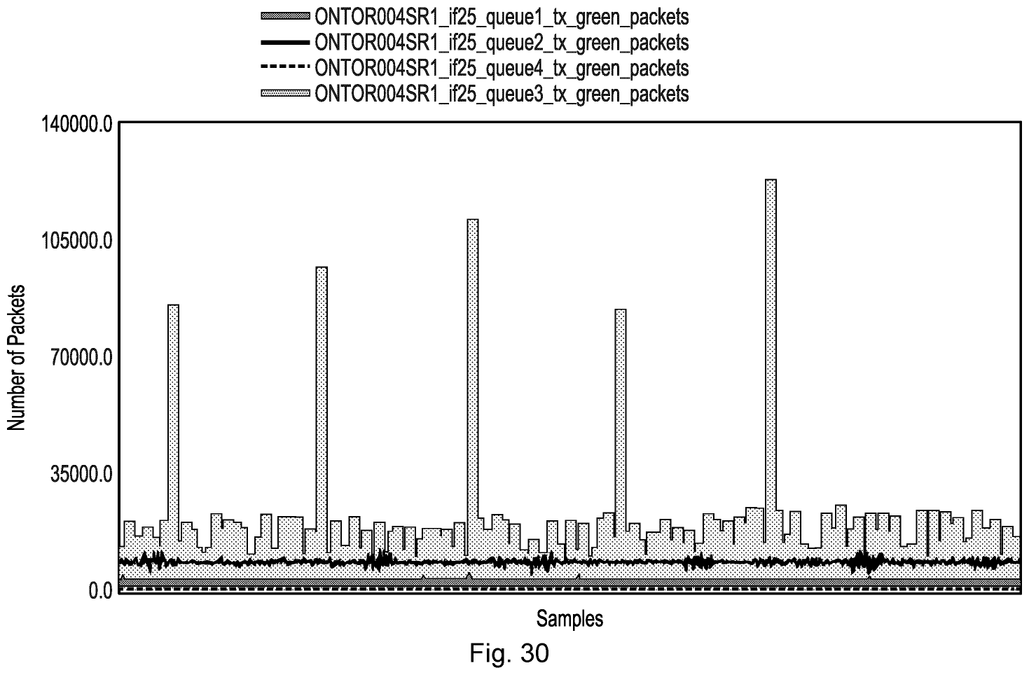

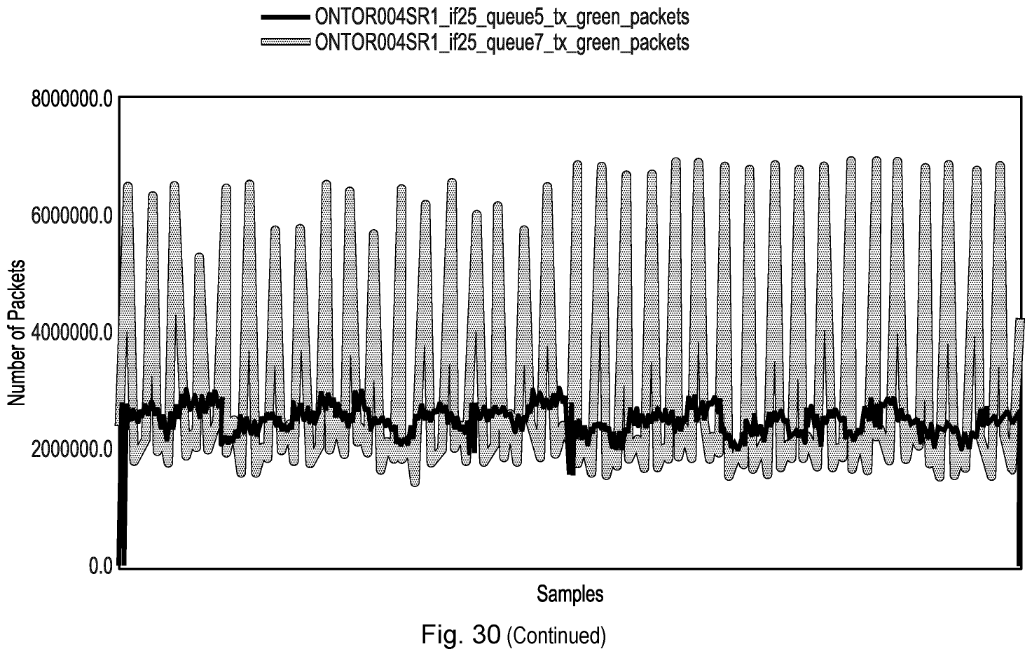

FIGS. 30a-b illustrate a change in a network traffic pattern for the ingress queues described above in Example 1. As illustrated, the change in the network traffic results in Queue 7 experiencing a bottleneck, due to the increased number of packets received at this queue compared to the other ingress queues.

The same operational state and observation transition probabilities as applied to the model used for Example 1, were used for Example 2. However, in Example 3 the POMDP policy was generated with the network traffic change, as illustrated in FIG. 30 used as the initial condition.

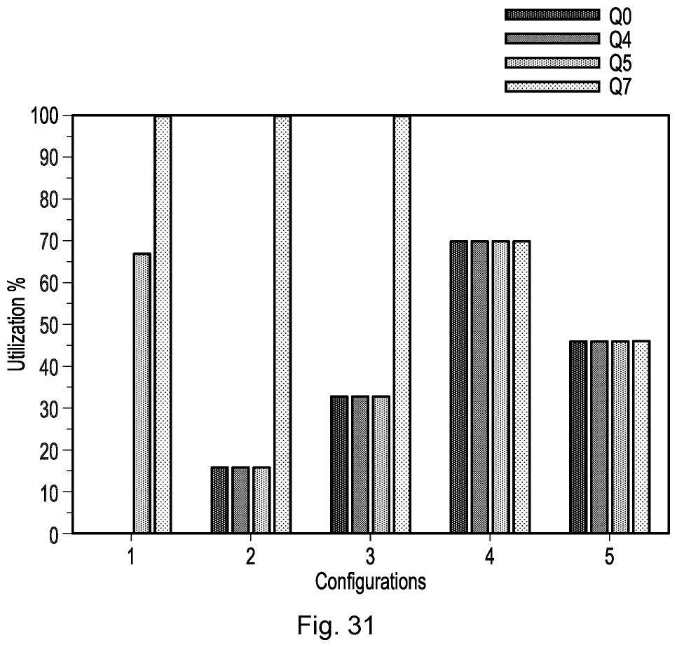

FIG. 31 illustrates the sequence of configuration changes applied to the router as dictated by the policy generated based on the network traffic change. As illustrated, the bottleneck in Q7 is alleviated thus illustrating the robustness of the method for generating a policy according to examples of the present disclosure.

Examples of the present disclosure thus provide a method that can generate a policy for managing a configuration of internal components of a communication network node. The policy can be generated on-the-fly and in response to changing network demands and traffic patterns. This is in contrast to conventional methods for generating a policy which rely on input from an expert. Examples of the present disclosure thus provide a method of generating a policy, which is more versatile, scalable, and accurate, compared to conventional methods of generating a policy.

Examples of the present disclosure are particularly advantageous in generating a policy for managing internal components of a communication network node that are not observable, such as for router. Based on suitable modelling, the policy can provide a belief of the operational state of the router and thus dictate the appropriate action to take to change the operational state accordingly in order to optimally change the configuration of a communication network node.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A computer implemented method for generating a policy for managing a configuration of internal components of a communication network node, wherein the communication network node is operable to process an input data flow, the method, performed by a training node, comprising:
obtaining performance data for the communication network node during a period of operation;
generating a model of the communication network node using the obtained performance data, the model representing an operational state of the communication network node for a given input data flow, wherein the operational state of the communication network node comprises a combined state formed from operational states of internal components of the communication network node;
using the model of the communication network node to generate a first data set comprising:
for a given input data flow to the communication network node, and for given configurations of internal components of the communication network node:
a representation of the operational state of the communication network node, and
an observed measure of performance of the communication network node;
extracting, from the first data set:
a set of conditional probabilities of operational state transition for the communication network node; and
a set of conditional probabilities of changes in observed measure of performance for the communication network node;
combining the extracted sets of conditional probabilities with a reward function for the communication network node performance to form a configuration model for the communication network node; and
generating a solution to the configuration model, the solution comprising a policy that is operable to propose a change in configuration of an internal component of the communication network node based on an observed measure of performance of the communication network node.

2. The method as claimed in claim 1, wherein the policy is operable to:
generate a belief state for the communication network node; and
map the belief state of the communication network node to a proposed configuration change for an internal component of the communication network node.

3. The method as claimed in claim 1, wherein the conditional probabilities of operational state transition for the communication network node, and the conditional probabilities of observed measure of performance for the communication network node, are conditional upon an initial state of the communication network node and on a change in configuration of an internal component.

4. The method as claimed in claim 1, wherein using the model of the communication network node to generate a first data set comprises, for a given input data flow to the communication network node, repeating the steps of:
inputting to the model a configuration of internal components of the communication network node;
obtaining model outputs comprising a representation of the operational state of the communication network node and an observed measure of performance of the communication network node;
changing a configuration of an internal component of the communication network node; and
obtaining model outputs comprising an updated representation of the operational state of the communication network node and an updated observed measure of performance of the communication network node.

5. The method as claimed in claim 1, wherein extracting the set of conditional probabilities of operational state transition for the communication network node from the first data set comprises, for operational states of the communication network node, and for possible changes of configuration of internal components of the communication network node represented in the first data set:
determining a change in operational state of the internal components of the communication network node; and
determining, on the basis of the changes in operational state of the internal components, a probability that the communication network node will transition to each of a plurality of possible operational states of the communication network node.

6. The method as claimed in claim 1, wherein extracting the set of conditional probabilities of changes in observed measure of performance for the communication network node from the first data set comprises, for operational states of the communication network node, and for possible changes of configuration of internal components of the communication network node represented in the first data set:
determining a change in observed measure of performance for the internal components of the communication network node; and
determining, on the basis of the changes in observed measure of performance for the internal components, a probability of observing each of a plurality of changes in observed measure of performance for the communication network node.

7. The method as claimed in claim 1, wherein generating a solution to the configuration model, the solution comprising a policy that is operable to propose a change in configuration of an internal component of the communication network node based on an observed measure of performance of the communication network node, comprises:
using a Machine Learning, ML, process to generate the solution to the configuration model, the ML process comprising a model-based Reinforcement Learning, RL, process, wherein the model on which the RL process is based comprises the configuration model for the communication network node.

8. The method as claimed in claim 1, wherein generating a solution to the configuration model, the solution comprising a policy that is operable to propose a change in configuration of an internal component of the communication network node based on an observed measure of performance of the communication network node, comprises:
initiating a belief state of the communication network node to a current belief state;
initiating a first function to map a current belief state of the communication network node to a change in configuration of an internal component of the communication network node;
initiating a second function to map a current belief state, a change in configuration of an internal component of the communication network node, and an observed measure of communication network node performance, to an updated belief state; and
updating the first function using the configuration model.

9. The method as claimed in claim 8, wherein updating the first function using the configuration model comprises repeating the steps of:
using the first function to map a current belief state of the communication network node to a change in configuration of an internal component of the communication network node;
using the configuration model to predict an observed measure of performance of the communication network node, and a reward value, on execution of the change in configuration;
using the second function to map the initiated belief state, change in configuration, and predicted observed measure of communication network node performance, to an updated belief state; and
updating values of parameters of the first function so as to increase the probability that the first function will map belief states of the communication network node to changes in configuration of internal components of the communication network node that maximize the reward value predicted by the configuration model.

10. The method as claimed in claim 1, wherein the configuration model for the communication network node comprises a Partially Observable Markov Decision Process, POMDP, model.

11. The method according to claim 1, wherein the communication network node comprises a networking device, and wherein the internal components of the communication network node comprise at least one port queue of the networking device.

12. The method as claimed in claim 11, wherein a configuration of an internal component of the communication network node comprises at least one of:
queue weight;
queueing discipline;
queue bandwidth;
queue virtual interfaces;
queue Random Early Drop threshold;
flow priority;
arrival rate traffic scaling.

13. The method as claimed in claim 11, wherein an operational state of an internal component comprises a function of at least one of:
queue utilization;
queue length;
queue residence time.

14. The method as claimed in claim 11, wherein an observed measure of communication network node performance comprises at least one of:
communication network node throughput;
communication network node residence time,
network node utilization;
overall packet loss;
overall number of packets transmitted;
overall number of packets received;
overall number of packets waiting to be transmitted;
overall number of packets waiting to be received.

15. A computer implemented method for using a policy to manage a configuration of internal components of a communication network node, wherein the communication network node is operable to process an input data flow, the method, performed by a management node, comprising:
obtaining the policy from a training node, wherein the policy is operable to propose a change in configuration of an internal component of the communication network node based on an observed measure of performance of the communication network node, and has been generated using a method according to claim 1;
receiving an observed measure of performance of the communication network node;
using the policy to propose, based on the received observed measure of performance, a change in configuration of an internal component of the communication network node;
causing the proposed change in configuration to be executed on the internal component of the communication network node; and
receiving an updated observed measure of performance of the communication network node following execution of the change in configuration.

16. The method as claimed in claim 15, further comprising:
obtaining a reward value associated with the change in configuration of an internal component of the communication network node; and
evaluating performance of the policy on the basis of the obtained reward value.

17. The method as claimed in claim 16, further comprising:
updating a function for calculating the obtained reward value.

18. The method as claimed in claim 15, wherein the policy is operable to:
generate a belief state for the communication network node; and
map the belief state of the communication network node to a proposed configuration change for an internal component of the communication network node.

19. The method as claimed in claim 15, wherein the communication network node comprises a networking device, wherein the internal components of the communication network node comprise at least one port queue of the networking device.

20. The method as claimed in claim 19, wherein a configuration of an internal component of the communication network node comprises at least one of:
queue weight;
queueing discipline;
queue bandwidth;
queue virtual interfaces;
queue Random Early Drop threshold;
flow priority;
arrival rate traffic scaling.

21.-26. (canceled)
